(19) United States
(12) Patent Application Publication
(10) Pub. No.: US 2016/0069798 A1
(43) Pub. Date: Mar. 10, 2016

(54) TARGET SUBSTANCE CAPTURING DEVICE AND TARGET SUBSTANCE DETECTING DEVICE

(71) Applicant: NSK LTD., Shinagawa-ku, Tokyo (JP)

(72) Inventors: Keisuke YOKOYAMA, Kanagawa (JP); Hideki FURUKAWA, Kanagawa (JP); Nobuko OKUTANI, Kanagawa (JP); Kunihiko SASAO, Kanagawa (JP); Toshiaki OGUCHI, Kanagawa (JP)

(73) Assignee: NSK LTD., Shinagawa-ku, Tokyo (JP)

(21) Appl. No.: 14/784,604

(22) PCT Filed: Apr. 28, 2014
(86) PCT No.: PCT/JP2014/061899

§ 371 Date: Oct. 15, 2015

(30) Foreign Application Priority Data
Apr. 30, 2013 (JP) 2013-095947
Apr. 30, 2013 (JP) 2013-095953
Apr. 30, 2013 (JP) 2013-095974
Feb. 13, 2014 (JP) 2014-025826

(51) Int. Cl. G01N 21/47; G01N 21/75

(52) U.S. Cl. CPC G01N 21/47; G01N 21/75

(57) ABSTRACT

A target substance capturing device includes a supporting member to place and support a metal-film coated structure that captures a target substance, and including at least two holes opening at portions different from a portion where the metal-film coated structure is placed, a holding member that puts the metal-film coated structure in between the holding member and the supporting member, and including an opening portion that overlaps with the holes of the supporting member, and a portion that captures the target substance in the metal-film coated structure placed on the supporting member, and a covering member having transparency, and covering the opening portion of the holding member.

### CROSS REFERENCE TO RELATED APPLICATIONS

This application is a National Stage of International Application No. PCT/JP2014/061899, filed Apr. 28, 2014, claiming priority based on Japanese Patent Application Nos. 2013-095947, 2013-095953, 2013-095974, filed Apr. 30, 2013, and 2014-025826, filed Feb. 13, 2014, the contents of all of which are incorporated herein by reference in their entirety.

### BACKGROUND OF THE INVENTION

1. Field of the Invention

The present invention relates to a target substance capturing device that detects a target substance and a target substance detecting device including the target substance capturing device.

2. Description of the Related Art

As means to detect a target substance such as protein or a cell, or to measure the concentration, biosensors using a photonic crystal are known (for example, Non Patent Literatures 1 and 2). The biosensors described in Non Patent Literature 1 (hereinafter, Prior Art 1) and Non Patent Literature 2 (hereinafter, Prior Art 2) irradiates a photonic crystal substrate on which a gold thin film is formed with light, and measures change of a peak of a wavelength of reflected light reflected at the photonic crystal substrate, thereby to detect the target substance or measure the concentration of the target substance, and the like.

### PRIOR ART

Prior Art 1 (Non Patent Literature 1): “Investigation of Plasmon resonances in metal films with nanohole arrays for biosensing applications”: Takumi Sannomiya, Olivier Scholder, Konstantins Jefimovs, Christian Hafner, and Andreas B. Dahlin, Received 10th December 2010, Revised 1th February 2011

Prior Art 2 (Non Patent Literature 2): “Periodic nanohole arrays with shape-enhanced plasmon resonance”: Antoine Lesuffleur, Hyungsoon Im, Nathan C. Lindquist and Sang-Hyun Oh, Received 16 Apr. 2007; accepted 17 May 2007; published online 13 Jun. 2007

In a case of detecting the target substance using the biosensors, the biosensors are detached to change a liquid to be detected, and when mounting the biosensors again after detached, there is a possibility that a mounting state differs. If the mounting state of the biosensor differs, detection sensitivity of the target substance may be decreased due to the difference in the mounting state.

Further, the photonic crystal has a microstructure. Therefore, it is difficult to finely control the shape, even if a manufacturing process is the same. Therefore, variation occurs in each sensor, and measurement accuracy of the target substance may be decreased.

Further, Prior Art 2 describes that real-time measurement has been performed using the biosensor. In Prior Art 2, the reflected light of the light irradiating the photonic crystal substrate that is exposed to a solution in a flow path is observed in each fixed time. Typically, change of the reflected light of light irradiating the photo crystal substance is fast as the flow speed of the solution is larger. However, if the flow speed of the solution is made large, the amount of the solution that passes through the photonic crystal substrate without having a reaction with the photonic crystal substrate becomes large, and the amount of the solution necessary to reach an equilibrium state becomes large. Therefore, a target substance capturing device that can decrease the amount of the solution necessary to reach the equilibrium state while causing the change of the reflected light of light irradiating the photonic crystal substrate to be fast is desired.

An objective of the present invention is to realize at least one of suppression of decrease in detection sensitivity of a target substance, and providing of a target substance capturing device that can decrease the amount of a solution necessary to reach an equilibrium state while causing change of reflected light of light irradiating a photonic crystal substrate to be fast.

### SUMMARY OF THE INVENTION

According to an aspect of the invention, a target substance capturing device comprises a supporting member to place and support a metal-film coated structure that captures a target substance, the supporting member including at least two holes opening at portions different from a portion where the metal-film coated structure is placed; a holding member to put the metal-film coated structure in between the holding member and the supporting member, the holding member including an opening portion that overlaps with the holes of the supporting member, and a portion that captures the target substance of the metal-film coated structure placed on the supporting member; and a covering member having transparency and covering the opening portion of the holding member. Accordingly, it is not necessary to detach the metal-film coated structure even if a liquid to be detected is changed. Therefore, a decrease in detection sensitivity of the target substance due to difference in a mounting state of the metal-film coated structure can be suppressed.

According to further aspect of the invention, the holes are two of a supply hole and an discharge hole, the supply hole supplying a liquid containing the target substance to a space surrounded by the covering member, an inner surface of the opening portion, and the supporting member, and the discharge hole discharging the liquid from the space. Accordingly, the liquid can be supplied to the opening portion and can be discharged through the opening portion.

According to further aspect of the invention, a portion of the holding member, the portion being in contact with the metal-film coated structure, is formed of at least silicone. Accordingly, the metal-film coated structure can be easily detached from the holding member.

According to further aspect of the invention, the supporting member is formed of a fluororesin. Accordingly, the metal-film coated structure can be easily detached from the supporting member.

According to further aspect of the invention, the supporting member has transparency. Accordingly, not only the reflected light of the light irradiating the metal-film coated structure but also transmitted light can be observed.

According to further aspect of the invention, the supporting member includes a plurality of claws to engage with the holding member that puts the metal-film coated structure in between the holding member and the supporting member, at a side where the metal-film coated structure is placed. Accordingly, the holding member and the covering member can be easily mounted to the supporting member, and the holding member and the covering member can be easily detached from the supporting member.

According to further aspect of the invention, the covering member is fitted into the opening portion of the holding member. Accordingly, the holding member and the covering member can be easily mounted to the supporting member, and the holding member and the covering member can be easily detached from the supporting member.

According to further aspect of the invention, a target substance detecting device includes the target substance capturing device as described above. This target substance detecting device includes the above-described target substance capturing device. Therefore, a decrease in the detection sensitivity of the target substance can be suppressed.

According to further aspect of the invention, the target substance detecting device includes a liquid sending device supplying the liquid to the space through the hole, and to discharge the liquid from the space through the hole. Accordingly, the liquid can be easily supplied to the opening portion of the holding member, and can be easily discharged through the opening portion.

According to further aspect of the invention, the photo-detection section includes a first spectrometer and a second spectrometer having higher resolution of a wavelength of detectable light than the first spectrometer, and the processing unit obtains the wavelength of an extreme value of the reflected light, using the first spectrometer, and then obtains the wavelength of an extreme value of the reflected light, within a range of the wavelength of an extreme value obtained by the first spectrometer, using the second spectrometer. Accordingly, the wavelength of the extreme value of the reflected light can be promptly and accurately obtained.

According to further aspect of the invention, the wavelength of an extreme value of the reflected light is obtained, by performing fitting of at least one of a detection result of the first spectrometer and a detection result of the second spectrometer, with a function. Accordingly, higher resolution than pixel resolution of the spectrometer can be realized. Therefore, the wavelength of the reflected light in the extreme value can be more accurately obtained.

According to further aspect of the invention, the target substance detecting device includes a cooling unit configured to cool the photo-detection section. Accordingly, a noise due to heat can be decreased in detecting a spectrum of the reflected light.

According to another aspect of the invention, a target substance capturing device includes a supporting member to place and support a metal-film coated structure that captures a target substance; a holding member to put the metal-film coated structure in between the holding member and the supporting member, the holding member including a plurality of opening portions that overlaps with a portion that captures the target substance of the metal-film coated structure; a covering member having transparency and covering the opening portions of the holding member; and holes provided in the supporting member, and two of the holes opening to one of the opening portions, respectively, in a state where the metal-film coated structure is put in between the holding member and the supporting member. This target substance capturing device can introduce the liquid to each opening portion included in the supporting member. Therefore, the metal-film coated structure can be calibrated at the same time as the detection. As a result, the target substance capturing device can realize highly accurate measurement.

In one of the opening portions, a supply hole that supplies a liquid containing the target substance to the opening portion, and an discharge hole that discharges the liquid from the opening portion are provided as the holes. Accordingly, the liquid can be supplied to each opening portion, and can be discharged through the each opening portion.

A portion of the holding member, the portion being in contact with the metal-film coated structure, is formed of at least silicone. Accordingly, the metal-film coated structure can be easily detached from the holding member.

The supporting member is formed of a fluororesin. Accordingly, the metal-film coated structure can be easily detached from the supporting member.

According to still another aspect of the invention, a target substance detecting device includes the target substance capturing device described above; a photo-detection section provided to each of the opening portions, and irradiating a portion that captures the target substance with parallel light from each of the opening portions, and detecting reflected light of the parallel light reflected at the portion that captures the target substance; and a processing unit configured to obtain a wavelength of an extreme value of the reflected light detected by the photo-detection section, and to detect existence/non-existence of at least the target substance, based on shifting of the obtained wavelength of an extreme value. This target substance detecting device includes the above-described target substance capturing device. Therefore, a decreased in the detection accuracy of the target substance can be suppressed.

The target substance detecting device includes a liquid sending device configured to supply the liquid to the space through the hole, and to discharge the liquid from the space through the hole. Accordingly, the liquid can be easily supplied to each opening portion included in the holding member, and can be easily discharged through the each opening portion.

According to still another aspect of the invention, a target substance capturing device includes a flow path to flow a fluid containing a target substance; and a substrate to capture the target substance, the substrate including a reflection surface that reflects irradiating light. The substrate is arranged in the flow path such that a part of the fluid passes through at least the reflection surface, and the fluid that has passed through the flow path is repeatedly introduced to the flow path.

The target substance capturing device according to the present invention repeatedly introduces a fluid to the reflection surface. Therefore, the solution that has passed through the photonic crystal substrate without having a reaction with the photonic crystal substrate can repeatedly obtain an opportunity to react with the photonic crystal substrate. Therefore, the amount of the solution to reach the equilibrium state is not increased even if the flow speed of the solution is made large. Therefore, the target substance detecting device according to the present invention can decrease the amount of the fluid necessary to reach the equilibrium state while causing change of the reflected light of the light irradiating the photonic crystal substrate to be fast.

The flow path includes a supply port through which the fluid flows in, and a discharge port through which the fluid flows out, and the fluid discharged through the discharge port is introduced to the flow path through the supply port. Accordingly, power that causes the fluid to flow can be installed outside the flow path. Since the flow path is extremely small, assembly of the target substance capturing device becomes easy if the power can be installed outside the flow path. Therefore, the target substance capturing device according to the present invention can be easily assembled, and can decrease the amount of the solution necessary to reach the equilibrium state while causing the change of the reflected light of the light irradiating the photonic crystal substrate to be faster.

The target substance capturing device further includes a container in which a new fluid containing a target substance is stored, wherein the new fluid is introduced to the flow path through the supply port.

The target substance capturing device further includes a plate table; a thin plate configured to overlap on the table in a vertical direction to a surface of the table, and including an opening portion; and a plate cover configured to overlap on the thin plate in a vertical direction to a surface of the table. The flow path is a space surrounded by the table, an inner surface of the opening portion, and the cover. Accordingly, the flow path can be formed to be thin, and a flow speed of the fluid flowing on a plane vertical to the reflection surface can be made large. Accordingly, the target substance can be promptly captured on the reflection surface. Therefore, the target substance capturing device according to the present invention can decrease the amount of the solution necessary to reach the equilibrium state while causing change of the reflected light of the light irradiating the photonic crystal substrate to be faster.

The supply port and the discharge port are through holes provided in the table.

The present invention can realize at least one of suppression of a decrease in detection sensitivity of a target substance, and providing of a target substance capturing device that can decrease the amount of a solution necessary to reach an equilibrium state while causing change of reflected light of light irradiating a photonic crystal substrate to be fast.

### BRIEF DESCRIPTION OF THE DRAWINGS

FIG. 1 is a diagram illustrating a target substance detecting device including a target substance capturing device according to a first embodiment.

FIG. 2 is a side view of a photonic crystal biosensor according to the first embodiment.

FIG. 3 is a perspective view of the photonic crystal biosensor according to the first embodiment.

FIG. 4 is a plan view of the photonic crystal biosensor according to the first embodiment.

FIG. 5 is a perspective view of a metal-film coated photonic crystal.

FIG. 6 is a plan view of the metal-film coated photonic crystal.

FIG. 7 is a diagram illustrating a cross section of when the photonic crystal is cut in a plane perpendicular to a surface of the photonic crystal.

FIG. 8 is a diagram illustrating an A-A cross section in FIG. 6 in a case of protruding portions.

FIG. 9 is a partially enlarged diagram of a wall surface of a recessed portion.

FIG. 10 is a diagram for explaining a method of manufacturing a photonic crystal.

FIG. 11 is a diagram for explaining a method of manufacturing a photonic crystal.

FIG. 12 is a diagram for explaining a method of manufacturing a photonic crystal.

FIG. 13 is a diagram for explaining a principle of a photonic crystal biosensor.

FIG. 14 is a diagram for explaining a principle of a photonic crystal biosensor.

FIG. 15 is a diagram for explaining a principle of a photonic crystal biosensor.

FIG. 16 is a diagram for explaining a principle of a photonic crystal biosensor.

FIG. 17 is a diagram illustrating a relationship between intensity of an extreme value of reflected light and a wavelength.

FIG. 18 is a diagram illustrating a relationship between a wavelength shift amount in an extreme value of intensity of reflected light and concentration of avidin fixed to a reflection surface of a photonic crystal using biotin.

FIG. 19 is a diagram illustrating a structure of a measuring probe included in a photo-detection section illustrated in FIG. 1.

FIG. 20 is a diagram illustrating a pixel of a spectrometer included in a photo-detection device.

FIG. 21 is a diagram illustrating a pixel of a spectrometer included in a photo-detection device.

FIG. 22 is a diagram illustrating an example of a spectrum of reflected light detected by the spectrometer illustrated in FIG. 20.

FIG. 23 is a diagram illustrating an example of a spectrum of reflected light detected by the spectrometer illustrated in FIG. 21.

FIG. 24A is a diagram illustrating an example of a spectrum of reflected light of when a photo-detection element included in a spectrometer is not cooled.

FIG. 24B is a diagram illustrating an example of a spectrum of reflected light of when a photo-detection element included in a spectrometer is cooled.

FIG. 25A is a diagram illustrating an example of a spectrum of reflected light detected by a photo-detection element included in a spectrometer.

FIG. 25B is a diagram for explaining an example of obtaining a peak position by performing data fitting of a result illustrated in FIG. 25-1.

FIG. 25C is a diagram illustrating a peak position obtained from a detection result of a photo-detection device, and a peak position obtained by performing data fitting of the detection result of a photo-detection device.

FIG. 25D is a diagram illustrating a peak position obtained from a detection result of a photo-detection device, and a peak position obtained by performing data fitting of the detection result of a photo-detection device.

FIG. 25E is a diagram illustrating temporal change of a peak wavelength obtained from a detection result of a photo-detection device.

FIG. 25F is a diagram illustrating temporal change of a peak wavelength obtained by performing peak fitting of a detection result of a photo-detection device.

FIG. 25G is a flowchart illustrating processing of peak fitting.

FIG. 26 is a diagram illustrating a modification of a liquid handling section.

FIG. 27 is a diagram illustrating a modification of a liquid handling section.

FIG. 28 is a diagram illustrating a first modification of a photonic crystal biosensor.

FIG. 29 is a diagram illustrating the first modification of a photonic crystal biosensor.

FIG. 30 is a diagram illustrating the first modification of a photonic crystal biosensor.

FIG. 31 is a diagram illustrating a second modification of a photonic crystal biosensor.

FIG. 32 is a diagram illustrating the second modification of a photonic crystal biosensor.

FIG. 33 is a diagram illustrating a photonic crystal biosensor according to a second embodiment.

FIG. 34 is a diagram illustrating the photonic crystal biosensor according to the second embodiment.

FIG. 35 is a perspective view illustrating a photo-detection unit according to the second embodiment.

FIG. 36 is an exploded view of the photo-detection unit according to the second embodiment.

FIG. 37 is an exploded view of the photo-detection unit according to the second embodiment.

FIG. 38 is a diagram illustrating a target substance detecting device.

FIG. 39 is an explanatory diagram of a photonic crystal biosensor.

FIG. 40 is a diagram illustrating a state before a solution is supplied to a flow path.

FIG. 41 is a diagram illustrating a state in which a solution is circulated.

FIG. 42 is a flowchart illustrating an example of a method of circulating a solution.

FIG. 43 is an explanatory diagram of another circulation method.

FIG. 44 is a diagram illustrating change of a wavelength of an extreme value of reflected light with respect to time in an example and a comparative example.

FIG. 45 is a diagram illustrating an evaluation condition of a photo-detection section of a target substance detecting device.

FIG. 46 is a flowchart of a method of detecting a target substance.

FIG. 47 is a diagram for explaining a principle of a photonic crystal biosensor.

FIG. 48 is a diagram for explaining a principle of a photonic crystal biosensor.

FIG. 49 is a diagram for explaining a principle of a photonic crystal biosensor.

FIG. 50 is a diagram for explaining a principle of a photonic crystal biosensor.

FIG. 51 is a diagram for explaining a principle of a photonic crystal biosensor.

### DETAILED DESCRIPTION OF THE PREFERRED EMBODIMENT

Hereinafter, embodiments for implementing the present invention (hereinafter, referred to as embodiments) will be explained in detail based on the drawings.

### First Embodiment

### Target Substance Detecting Device

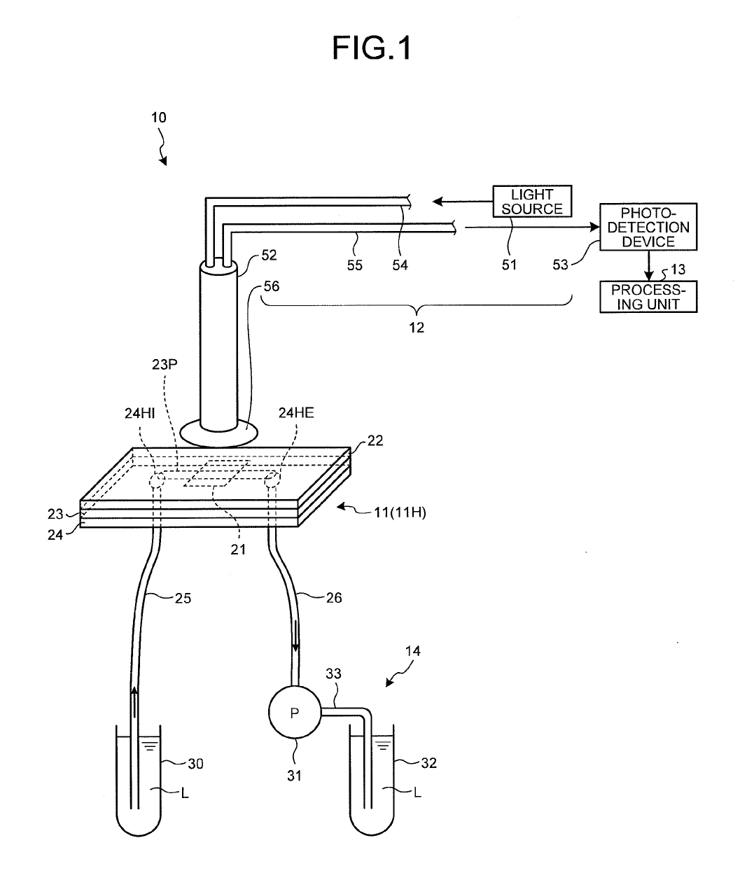

FIG. 1 is a diagram illustrating a target substance detecting device including a target substance capturing device according to a first embodiment. A target substance detecting device 10 includes a photonic crystal biosensor 11 as a target substance capturing device, a photo-detection section 12, a processing unit 13, and a liquid handling section 14. First, the photonic crystal biosensor 11 will be explained.

[Photonic Crystal Biosensor]

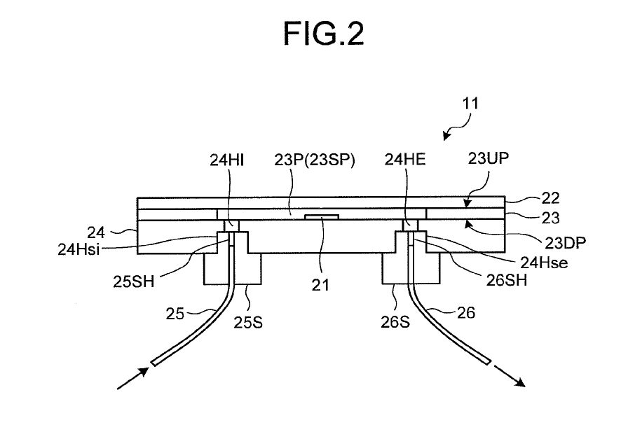

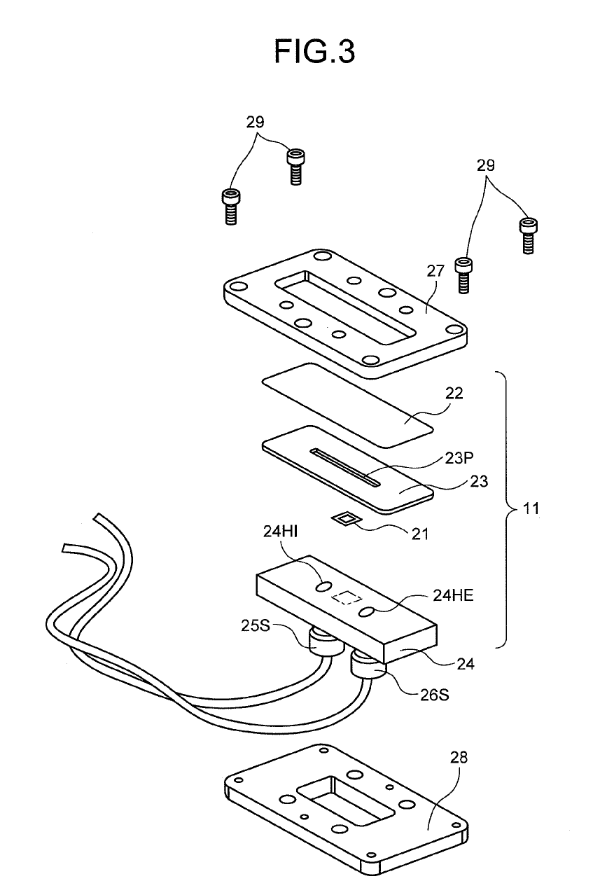

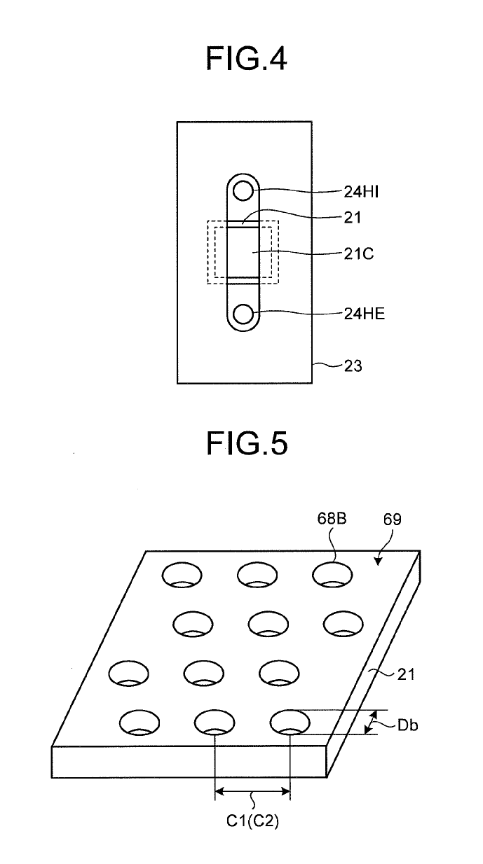

FIG. 2 is a side view of a photo crystal biosensor according to the first embodiment. FIG. 3 is a perspective view of the photonic crystal biosensor according to the first embodiment. FIG. 4 is a plan view of the photonic crystal biosensor according to the first embodiment. The photonic crystal biosensor 11 includes a holding device 11H and a metal-film coated photonic crystal 21 as a metal-film coated structure. The holding device 11H holds the metal-film coated photonic crystal 21. The holding device 11H includes a covering member 22, a holding member 23, and a supporting member 24.

In the photonic crystal biosensor 11, the holding device 11H holds the metal-film coated photonic crystal 21. In the holding device 11H, the holding member 23 holds the metal-film coated photonic crystal 21 placed on the supporting member 24, by putting the metal-film coated photonic crystal 21 in between the holding member 23 and the supporting member 24. The covering member 22 covers a surface of the holding member 23 of an opposite side to the supporting member 24. As illustrated in FIGS. 1 to 3, the supporting member 24, the holding member 23, and the covering member 22 are single plate members, respectively. In the present embodiment, the shapes of the supporting member 24, the holding member 23, and the covering member 22 are a rectangular shape (including a square shape) as viewed from a direction perpendicular to these surfaces, that is, in planar view. The shapes of the supporting member 24, the holding member 23, and the covering member 22 are not limited to the rectangular shape, and may be a polygonal shape such as a hexagonal shape or a circular shape. There are advantages that manufacturing can be easily performed, the holding device 11H can be easily mounted to mounting tools 27 and 28 illustrated in FIG. 3, and the like, with the rectangular shapes of the supporting member 24, the holding member 23, and the covering member 22.

The supporting member 24 supports the metal-film coated photonic crystal 21 placed thereon. The supporting member 24 includes at least two holes 24HI and 24HE that open to portions different from a portion where the metal-film coated photonic crystal 21 is placed, as illustrated in FIGS. 1 to 4. The holding member 23 puts the metal-film coated photonic crystal 21 in between the holding member 23 and the supporting member 24. The holding member 23 includes an opening portion 23P. As illustrated in FIG. 2, the opening portion 23P penetrates two largest facing planes 23UP and 23DP of the holding member 23 that is a plate member. As illustrated in FIGS. 1, 3, and 4, the opening portion 23P has a rectangular shape in plan view, and is a groove-shaped passage. As illustrated in FIG. 4, the opening portion 23P overlaps with the holes 24HI and 24HE of the supporting member 24 and a portion 21C that captures a target substance of the metal-film coated photonic crystal 21 placed on the supporting member 24. The hole 24HI supplies a liquid such as a solution that contains a target substance capturing material to the opening portion 23P. The hole 24HE discharges the liquid such as a solution that contains a target substance capturing material from the opening portion 23P. Hereinafter, the hole 24HI is appropriately called a supply hole 24HI, and the hole 24HE is appropriately called an discharge hole 24HE.

The covering member 22 covers the opening portion 23P of the holding member 23, as illustrated in FIGS. 1 and 2. The covering member 22 has transparency. This is because the metal-film coated photonic crystal 21 is irradiated with light through the covering member 22, and change of a peak of a wavelength of reflected light reflected by the metal-film coated photonic crystal 21 is measured, so that the target substance is detected or the concentration of the target substance is measured. As the covering member 22, a glass plate, a transparent resin plate, or a resin film is used, for example.

The liquid such as a solution that contains a target substance capturing material is supplied through the supply hole 24HI to a space 23SP surrounded by the covering member 22, an inner surface of the opening portion 23P, and the supporting member 24, and is held in the space 23SP. The liquid held in the space 23SP is in contact with the portion 21C that captures the target substance of the metal-film coated photonic crystal 21. The liquid held in the space 23SP is held in the space 23SP during detection of the target substance by the target substance detecting device 10 or measurement of the concentration of the target substance. After the detection of the target substance by the target substance detecting device 10 and the like, the liquid held in the space 23SP is discharged through the discharge hole 24HE. To supply the liquid from an outside of the photonic crystal biosensor 11 to the space 23SP, a liquid supply pipe 25 is connected to the photonic crystal biosensor 11. To discharge the liquid to an outside of the photonic crystal biosensor 11 from the space 23SP, a liquid discharge pipe 26 is connected to the photonic crystal biosensor 11. Next, an example of a structure in which the liquid supply pipe 25 and the liquid discharge pipe 26 are connected to the space 23SP will be explained. As the liquid supply pipe 25 and the liquid discharge pipe 26, a tube made of silicon rubber or the like can be used, for example. However, the material is not limited to the silicon rubber tube.

As illustrated in FIG. 2, the supporting member 24 having the supply hole 24HI includes holes 24Hsi and 24Hse in a surface opposite to the surface on which the metal-film coated photonic crystal 21 is placed. The hole 24Hsi is connected with the supply hole 24HI. The hole 24Hse is connected with the discharge hole 24HE. In the present embodiment, the holes 24Hsi and 24Hse, the supply hole 24HI and the discharge hole 24HE have a circular cross section. The diameter of the hole 24Hsi is larger than that of the supply hole 24HI. The diameter of the hole 24Hse is larger than that of the discharge hole 24HE. A connecting member 25S that connects the supply hole 24HI and the liquid supply pipe 25 is mounted in the hole 24Hsi. A connecting member 26S that connects the discharge hole 24HE and the liquid discharge pipe 26 is mounted in the hole 24Hse. The connecting members 25S and 26S are made of rubber, a resin, or metal. The connecting members 25S and 26S respectively include mounting holes 25SH and 26SH. The liquid supply pipe 25 is inserted in the mounting hole 25SH and mounted in the connecting member 25S. The liquid discharge pipe 26 is inserted in the mounting hole 26SH and mounted in the connecting member 26S. With such a structure, the liquid supply pipe 25 is mounted in the hole 24Hsi of the supporting member 24 through the connecting member 25S. Further, the liquid discharge pipe 26 is mounted in the hole 24Hse of the supporting member 24 through the connecting member 26S. The hole 24Hsi in which the liquid supply pipe 25 is mounted is connected to the supply hole 24HI, and the hole 24Hse in which the liquid discharge pipe 26 is mounted is connected to the discharge hole 24HE. Therefore, the liquid supply pipe 25 is connected with the space 23SP through the connecting member 25S and the supply hole 24HI. The liquid discharge pipe 26 is connected with the space 23SP through the connecting member 26S and the discharge hole 24HE.

The photonic crystal biosensor 11 sandwiches the metal-film coated photonic crystal 21 by the supporting member 24 and the holding member 23. The mounting tools 27 and 28 are fastened with bolts 29 illustrated in FIG. 3, in a state of putting the supporting member 24 and the holding member 23 that sandwich the metal-film coated photonic crystal 21 in between the mounting tools 27 and 28. With such a structure, the photonic crystal biosensor 11 is sandwiched and supported by the mounting tools 27 and 28 illustrated in FIG. 3, in a state of mounting the covering member 22 on the holding member 23. The supporting member 24, the holding member 23, and the metal-film coated photonic crystal 21 can be integrally held by the mounting tools 27 and 28, thus can be easily handled. Further, the mounting tools 27 and 28 are fastened with the bolts 29, so that disassembly of the photonic crystal biosensor 11 becomes easy. Fixation of the mounting tools 27 and 28 is not limited to the fastening with the bolts 29.

In the present embodiment, a portion of the holding member 23, the portion being in contact with the metal-film coated photonic crystal 21, is formed of at least silicone, for example, polydimethylsiloxane (PDMS). The polydimethylsiloxane has high liquid repellency (water repellency), and thus can suppress adhesion of the metal-film coated photonic crystal 21 and the holding member 23. Therefore, when the metal-film coated photonic crystal 21 is replaced, the metal-film coated photonic crystal 21 can be easily detached from the holding member 23. The thickness of the holding member 23 is preferably from 100 μm to 2 mm, both inclusive. With such thickness, fixation of the metal-film coated photonic crystal 21 in between the supporting member 24 and the holding member 23 can be easily handled.

In order to flow the liquid on the metal-film coated photonic crystal 21, a provisional idea of providing a space keeping portion to make a space through which the liquid flows on a sensor surface is considered. The thickness of the space keeping portion depends on a wavelength of plasmon resonance. Therefore, the thickness is limited depending on a wavelength band to be used. If such a structure is employed, the thickness of the space keeping portion requires strict accuracy, and a time and a manufacturing cost are required at the time of manufacturing. The present embodiment does not require the space keeping portion, and thus the manufacturing of the photonic crystal biosensor 11 becomes easy, and the time and the manufacturing cost can be suppressed. Further, with respect to a surface plasmon (SPR) sensor, it is important to fix the sensor and a prism, because the surface plasmon sensor does not function as a sensor if a small gap or bending is formed. However, the metal-film coated photonic crystal 21 of the present embodiment does not require the strict fixation like the SPR sensor.

In the present embodiment, the supporting member 24 is formed of a fluororesin. Although the material of the supporting member 24 is not limited to the fluororesin, the fluororesin has high liquid repellency (water repellency), and thus can suppress adhesion between the metal-film coated photonic crystal 21 and the supporting member 24. Therefore, when the metal-film coated photonic crystal 21 is replaced, the metal-film coated photonic crystal 21 can be easily detached from the holding member 23. The supporting member 24 may have transparency. With such a configuration, transmitted light of light irradiating the metal-film coated photonic crystal 21 can be observed. When the supporting member 24 has transparency, the supporting member 24 is manufactured using glass or a transparent resin, for example. When glass is used for the supporting member 24, the metal-film coated photonic crystal 21 is fixed between the supporting member 24 and the holding member 23, by a joining technology such as self-adsorption between the glass supporting member 24 and the polydimethylsiloxane holding member 23, gluing between the supporting member 24 and the holding member 23, or heat seal of the polydimethylsiloxane holding member 23. Next, the metal-film coated photonic crystal 21 will be explained.

[Metal-Film Coated Photonic Crystal]

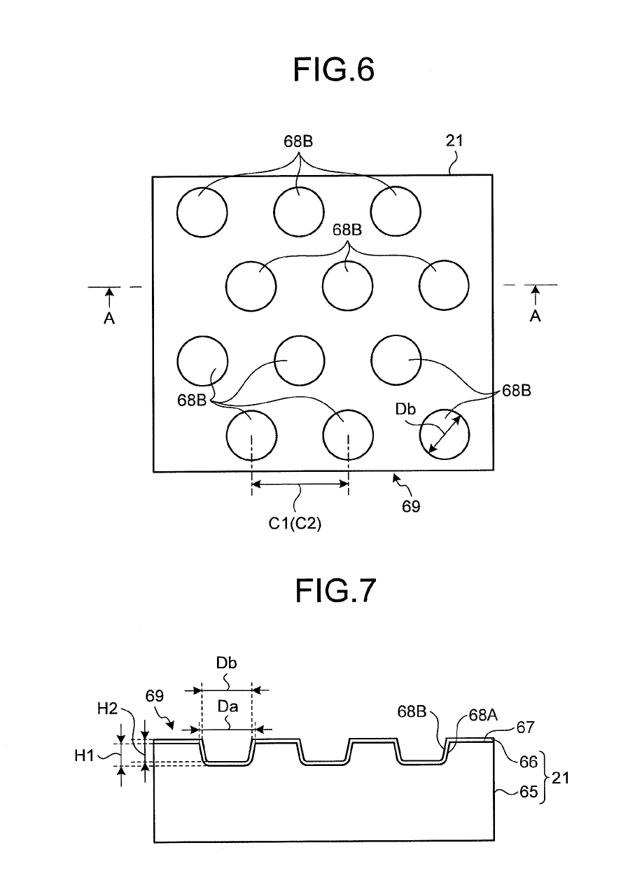

FIG. 5 is a perspective view of the metal-film coated photonic crystal. FIG. 6 is a plan view of the metal-film coated photonic crystal. FIG. 7 is a diagram illustrating the A-A cross section of FIG. 6. FIG. 7 illustrates a cross section of when the photonic crystal is cut in a plane perpendicular to a surface of the photonic crystal. FIG. 9 explained below is also similar. Note that FIGS. 5 to 9 are schematically illustrated diagrams, and thus the thickness, the size, and the like of each element of the metal-film coated photonic crystal 21 are different from actual dimensions. The same applies to the description below. The metal-film coated photonic crystal 21 captures the target substance. As illustrated in FIGS. 5 to 7, the metal-film coated photonic crystal 21 includes a photonic crystal 65 and a metal film 66. The metal-film coated photonic crystal 21 has a reflection surface 69 coated with the metal film 66, the reflection surface 69 being formed such that recessed portions (hereinafter, simply referred to as recessed portions) 68A having a circular cross section are periodically formed on a surface 67 of the photonic crystal 65.

First, the photonic crystal 65 will be explained. The photonic crystal is a structure that has a reflection surface having a surface where recessed portions having a predetermined depth or protruding portions having a predetermined height are periodically formed, and can obtain reflected light when the reflection surface is irradiated with light having a specific wavelength (parallel light). The structure that can obtain the reflected light having a specific wavelength when the reflection surface having a surface where recessed portions or protruding portions are periodically formed is irradiated with the light is typically called a photonic crystal.

The photonic crystal is a structure having a grid structure with a subwavelength interval. Then, when a surface of the structure (hereinafter, referred to as reflection surface) is irradiated with light having a wide region wavelength, the photonic crystal reflects or transmits light in a specific wavelength band depending on a surface state of the photonic crystal. The surface state of the photonic crystal depends on the shape or the material of the photonic crystal, for example. By reading change of the reflected light or the transmitted light, change of the surface state of the photonic crystal can be quantified. Examples of the change of the surface state of the photonic crystal include absorption of a substance to the surface, and structure change. When the photonic crystal having a surface on which a metal thin film is formed is irradiated with light, an extreme value (a maximum value of a minimum value) appears in reflectance of light or transmittance of light. The extreme value of the reflectance or the transmittance depends on a type of the metal, a film thickness of the metal, and the shape of the surface of the photonic crystal. By reading the reflectance of light or the transmittance of light, the change of the surface state of the photonic crystal can be quantified. The metal thin film will be explained below. To quantify the change of the surface state of the photonic crystal from the change of the reflected light or the transmitted light, the following method can be used. For example, an amount of change of the reflectance or the transmittance in the extreme value (a maximum value of a minimum value), or a shift amount of a wavelength with which the reflectance or the transmittance becomes the extreme value is obtained. Note that, when there is a plurality of extreme values of the reflectance and the transmittance, an arbitrary extreme value is focused. Then, the amount of change of the focused extreme value or the shift amount of the wavelength with which the focused extreme value is obtained is obtained, so that the change of the surface state of the photonic crystal can be quantified.

As illustrated in FIGS. 5 to 7, the photonic crystal 65 has the reflection surface 69 having the surface 67 in which the recessed portions (non-flat portions) 68A are periodically formed. When the reflection surface 69 is irradiated with light, light having a specific wavelength depending on the shape and the material of the photonic crystal 65 is reflected. In the present embodiment, the recessed portions 68A are arranged in a triangular grid manner in a planar view. Further, a diameter Da of the recessed portion 68A is preferably from 50 nm to 1000 nm, both inclusive, and is more preferably from 100 nm to 500 nm, both inclusive. Further, a distance C1 between centers of the recessed portions 68A is preferably from 100 nm to 2000 nm, both inclusive, and is more preferably from 200 nm to 1000 nm, both inclusive. Further, an aspect ratio (H1/Da) of the recessed portion 68A, where the depth of the recessed portion 68A is H1, is preferably from 0.1 to 10, both inclusive, and is more preferably from 0.5 to 5.0, both inclusive. Note that dimensions of the recessed portion 68A are not limited to the above-described dimensions.

The shape and the dimensions of the photonic crystal 65 are not limited to the shape illustrated in FIGS. 5 to 7. For example, the photonic crystal 65 may have a shape having a surface on which a rectangular or polygonal grid pattern is formed, a shape on which a parallel line pattern or a wave-shaped pattern is formed (to be specific, the patterns are periodically formed), or a shape having a combination of the aforementioned patterns. As the material of the photonic crystal 65, an organic material such as a synthetic resin, or an inorganic material such as a metal or a ceramic can be used.

As the synthetic resin, a thermoplastic resin such as polyethylene, polypropylene, polymethylpentene, polycycloolefin, polyamide, polyimide, acryl, polymethacrylic acid ester, polycarbonate, polyacetal, polytetrafluoroethylene, polybutylene terephthalate, polyethylene terephthalate, polyvinyl chloride, polyvinylidene chloride, polystyrene, polyphenylene sulfide, polyether sulfone, or polyetheretherketone, or a thermosetting resin such as a phenol resin, a urea resin, or an epoxy resin, can be used.

As the ceramic, a ceramic such as silica, alumina, zirconia, titania, or yttria can be preferably used. As the metal, various alloys including a steel material can be used. To be specific, stainless steel, titanium or a titanium alloy can be preferably used.

Among the above-described various materials, a polycycloolefin-based synthetic resin or a silica-based ceramic is more preferable, in light of optical characteristics, processability, tolerance to a solution containing a target substance (a substance to be targeted), absorbability of the target substance capturing material (specific bonding substance), and tolerance to a washing agent. Between the polycycloolefin-based synthetic resin and the silica-based ceramic, the polycycloolefin-based synthetic resin is most preferable because of excellent processability.

The photonic crystal 65 is manufactured by application of fine processing to a surface of a substrate made of the above-described material. As a processing method, laser processing, heat nanoimprint, optical nanoimprint, or a combination of a photo mask and etching can be used. Especially, when the thermoplastic resin such as the polycycloolefin-based synthetic resin is used as the material, a method by the heat nanoimprint is preferable.

Next, the metal film 66 will be explained. In the present embodiment, as illustrated in FIG. 7, the reflection surface 69 of the photonic crystal 65 is coated with the metal film 66. The metal film 66 is preferably formed using any one or more types of gold (Au), silver (Ag), platinum (Pt), and aluminum (Al). In the present embodiment, the metal film 66 is formed of Au. Au is excellent in stability, and is thus preferable as the reflection surface 69. When any one or more types of silver (Ag) and aluminum (Al) are used as the metal film 66, it is preferable to coat the surface with gold. Accordingly, a use amount of gold can be decreased, and a manufacturing cost of the photonic crystal 65 can be suppressed. Further, a decrease in a function due to oxidation of Ag and Al can be suppressed.

When the film thickness of the metal film 66 is small, a part of incident light on the photonic crystal 65 may transmit the metal film 66. As a result, there is a possibility that an amount of information obtained from reflected light from the photonic crystal 65 decreases, and that unnecessary information, such as diffracted light or reflected light from a back surface of the photonic crystal 65 is included in the reflected light. By appropriately making the film thickness of the metal film 66 large, the unnecessary information included in the reflected light from the photonic crystal 65 can be decreased, and detection accuracy of the target substance and measurement accuracy of the concentration can be improved. Further, suitably small film thickness of the metal film 66 is preferable in easily manufacturing a detailed pattern shape on the surface 67 of the photonic crystal 65. For example, a corner of the pattern becomes sharp, and the dimension of the pattern can be easily secured. Based on the above perspective, the film thickness of the metal film 66 is preferably from 30 nm to 1000 nm, both inclusive, and is more preferably from 150 nm to 500 nm, both inclusive, and is still more preferably from 200 nm to 400 nm, both inclusive, in the present embodiment. This is because change of the reflectance to the wavelength becomes nearly similar when the film thickness of the metal film 66 exceeds 200 nm.

The metal film 66 can be formed on the reflection surface 69 of the photonic crystal 65 by means of sputtering, a deposition apparatus, or the like. It is preferable to form an outermost surface of the metal film 66 with Au. When Ag, Pt, or Al is used as the metal film 66, the wavelength of the reflected light in each extreme values becomes 1.5 times that of the case where Au is used as the metal film 66. As explained above, sensitivity of Ag, Pt, and Al is 1.5 times that of Au. Since Ag is easily oxidized, it is preferable to form an oxide thin film of Au or SiO₂, which is less easily oxidized, after forming Ag on the reflection surface 69 of the photonic crystal 65. In this case, a film of Au having the thickness of 5 nm can be formed on a surface of a film of Ag having the thickness of 200 nm. When the film of Au having the thickness of 5 nm is formed on the film of Ag having the thickness of 200 nm, the sensitivity becomes 1.5 times that of a film of Au having the thickness of 200 nm. Further, no change of the sensitivity is seen between existence and non-existence of the film of Au of 5 nm. Al is also easily oxidized similarly to Ag, and thus it is preferable to form an oxide thin film of Au or SiO₂, which is less easily oxidized, after forming a film of Al on the surface 67 of the photonic crystal 65. In a case of Pt, it is also preferable to form the oxide thin film of Au or SiO₂ because of modification with an antibody or the like.

Further, it is preferable to reform the reflection surface 69 of the photonic crystal 65, using 3-triethoxysilylpropylamine (APTES) or the like. When the metal film 66 of Au or Ag is formed on the reflection surface 69 of the photonic crystal 65, it is preferable to reform the reflection surface 69 of the photonic crystal 65, using a carbon chain having a thiol group in one end, and a functional group such as an amino group or a carboxyl group in the other end, instead of APTES. When the metal film 66 of other than Au or Ag is formed on the reflection surface 69 of the photonic crystal 65, it is preferable to reform the reflection surface 69 of the photonic crystal 65, using a silane-based coupling agent having a functional group in one end, for example, APTES.

The metal-film coated photonic crystal 21 is obtained such that the reflection surface 69 of the photonic crystal 65 is coated with the metal film 66. Therefore, recessed portions (non-flat portions) 68B of the metal-film coated photonic crystal 21 are periodically formed in the reflection surface 69, corresponding to the recessed portions 68A of the photonic crystal 65. The recessed portions 68B are arranged in a triangular grid manner, similarly to the recessed portions 68A. Further, although depending on the thickness of the metal film 66, a diameter Db of the recessed portion 68B is preferably from 50 nm to 1000 nm, both inclusive, and is more preferable from 100 nm to 500 nm, both inclusive. Further, a distance C2 between centers of the recessed portions 68B is preferably from 100 nm to 2000 nm, both inclusive, and is more preferably from 200 nm to 1000 nm, both inclusive, similarly to the distance C1 between centers of the recessed portions 68A. Further, an aspect ratio (H2/Db) of the recessed portion 68B, where the depth of the recessed portion 68B is H2, is preferably from 0.1 to 10, both inclusive, and is more preferably from 0.5 to 5.0, both inclusive. Note that dimensions of the recessed portion 68B are not limited to the above-described dimensions.

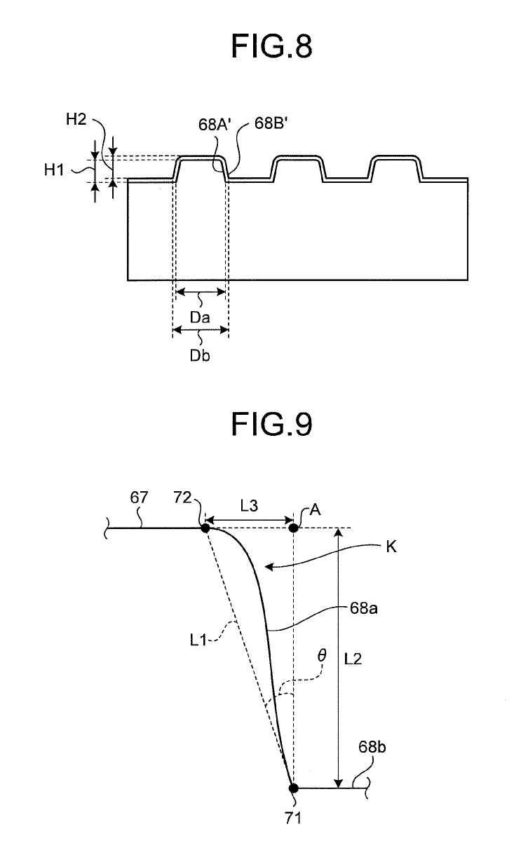

FIG. 8 is a diagram illustrating the A-A cross section in FIG. 6 of the case of the protruding portions. In the first embodiment of the above description, the recessed portions 68A and 68B as illustrated in FIG. 7 are non-flat portions. However, protruding portions 68A′ and 68B′ may be the non-flat portions, as illustrated in FIG. 8. The protruding portions 68A′ and 68B′ of this time are columnar protruding portions protruding from the surface 67.

FIG. 9 is a partially enlarged diagram of a wall surface of a recessed portion. The recessed portion 68B is formed such that a wall surface 68a of the recessed portion 68B is formed, having a predetermined angle with respect to a bottom surface 68b of the recessed portion 68B. Note that, in FIG. 9, the metal film 66 provided on the surface 67 of the photonic crystal 65 is omitted for convenience of explanation. As illustrated in FIG. 6, the wall surface 68a of the recessed portion 68B has a predetermined angle with respect to the flat bottom surface 68b of the recessed portion 68B. In a cross section that passes through the center of gravity of the bottom surface 68b of the recessed portion 68B, a boundary between the wall surface 68a and the bottom surface 68b of the recessed portion 68B is a first boundary portion 71. A boundary between the surface 67 and the wall surface 68a of the recessed portion 68B is a second boundary portion 72. An intersection of a straight line that passes through the first boundary portion 71 in a vertical direction to the bottom surface 68b, and a straight line that passes through the second boundary portion 72 in a horizontal direction to the bottom surface 68b is an intersection A. A distance connecting the first boundary portion 71 and the second boundary portion 72 with a straight line is L1. A distance connecting the first boundary portion 71 and the intersection A with a straight line is L2. A distance connecting the second boundary portion 72 and the intersection A with a straight line is L3. An angle made of the L1 and L2 is θ. At this time, in the recessed portion 68B, the angle θ made by the L1 and L2 is formed to satisfy the following expressions (1) and (2):

tan θ=L3/L2 (1)

0≦tan θ≦1.0 (2)

When a surface of a metal provided with a structure in which recessed holes are periodically arranged is irradiated with light, a peak is observed in a wavelength spectrum of reflected light. A wavelength (peak wavelength) with which the reflectance to the wavelength of the reflected light is maximized can be typically obtained by the following expression (3). In the expression (3), λₚₑₐₖ is the peak wavelength, a₀ is a period of the hole, i and j are an order of diffraction, ∈ₘ is a dielectric constant of the metal, and ∈_{d} is a dielectric constant of an environment.

$${λ}_{peak} = {{a}_{0} [ \frac{4}{3} ( {i}^{2} + ij + {j}^{2} ) ]}^{- 1 / 2} {( \frac{{ɛ}_{d} {ɛ}_{m}}{{ɛ}_{d} + {ɛ}_{m}} )}^{1 / 2} \qquad ( 3 )$$

According to the expression (3), the peak wavelength can be obtained when a period of arranging the recessed portion 68B is given. When the spectrum of the peak wavelength is observed, the position of the peak wavelength can be more easily identified if a width of the spectrum of the peak wavelength is smaller. Therefore, if the period of arranging the recessed portion 68B is clearly given, the width of the spectrum of the peak wavelength becomes small, and the position of the peak wavelength can be easily identified.

The metal-film coated photonic crystal 21 has a periodic structure in which the recessed portions 68B are periodically formed on the reflection surface 69. The wall surface 68a of the recessed portion 68B is formed on the reflection surface 69 to satisfy the expressions (1) and (2), so that the width of the form of the wavelength spectrum of the reflected light becomes narrow, and the peak wavelength of the reflected light can be easily identified. Accordingly, the target substance can be accurately detected. As a result, the sensor sensitivity of the photonic crystal biosensor 11 can be improved. Note that the width of the form of the wavelength spectrum of the reflected light is a half-value width or the like.

It is preferable to form the recessed portion 68B to satisfy the following expression (2)′. The wall surface 68a of the recessed portion 68B is formed to satisfy the above-described expression (1) and the following expression (2)′, so that the form of the wavelength spectrum of the reflected light becomes narrower, and the peak wavelength of the reflected light can be more easily identified. As a result, the target substance can be more accurately detected.

0≦tan θ≦0.7 (2)′

From the expressions (2) and (2)′, the angle θ is 0 degrees or more. When the angle θ=0 degrees, a connection portion K of the surface 67 of the metal-film coated photonic crystal 21, and the wall surface 68a of the recessed portion 68B have an angle of appropriately 90 degrees. When the connection portion K has the angle of approximately 90 degrees, control of the shape of the metal-film coated photonic crystal 21, especially, control of the shape of the recessed portion 68B becomes difficult. That is, it becomes difficult to obtain an expected shape of the recessed portion 68B. By satisfying tan θ>0, that is, by causing the angle θ to be larger than 0, the expected shape of the recessed portion 68B can be easily obtained, and thus it is preferable. Further, the metal-film coated photonic crystal 21 is washed with relatively high-pressure water. If the angle of the connection portion K becomes approximately 90 degrees, a corner is apt to be removed. As a result, there is a possibility that the recessed portion 68B does not have the expected shape. By satisfying tan θ>0, that is, by causing the angle θ to become larger than 0, the possibility of removal of the corner of the connection portion K decreases. Therefore, the recessed portion 68B has the expected shape after the washing, and thus it is preferable. Further, by satisfying tan θ>0, that is, by causing the angle θ to become larger than 0, water can easily enter the recessed portion 68B, and thus the target substance can be reliably captured in the recessed portion 68B.

[Method of Manufacturing Photonic Crystal]

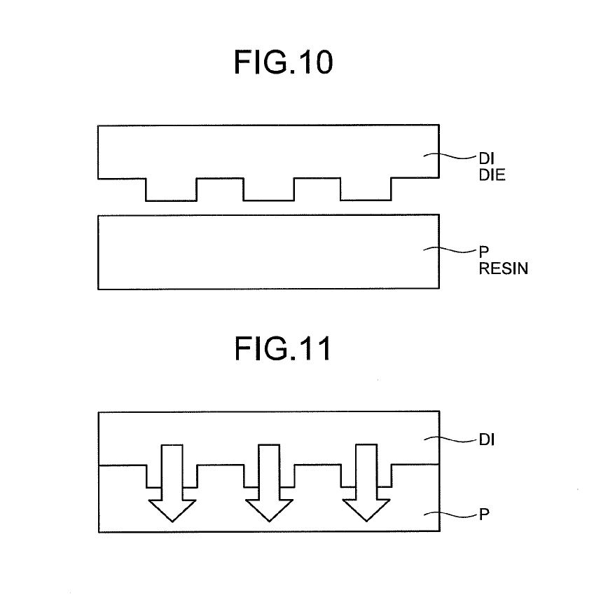

FIGS. 10 to 12 are diagrams for explaining a method of manufacturing a photonic crystal. An example of processes of manufacturing the metal-film coated photonic crystal 21 by heat nanoimprint will be explained with reference to these drawings. As illustrated in FIG. 10, in the heat nanoimprint, a die DI having a pattern of a nano-level microstructure, or a pattern of a nano-level periodic structure is used. Then, as illustrated in FIG. 11, the heated die DI is pressed against a sheet resin P and is pressed with predetermined pressure for a predetermined time. When a surface temperature of the die DI becomes a predetermined temperature, the die is released, and the microstructure or the periodic structure is transferred to the sheet resin P. Accordingly, the photonic crystal 65 can be obtained.

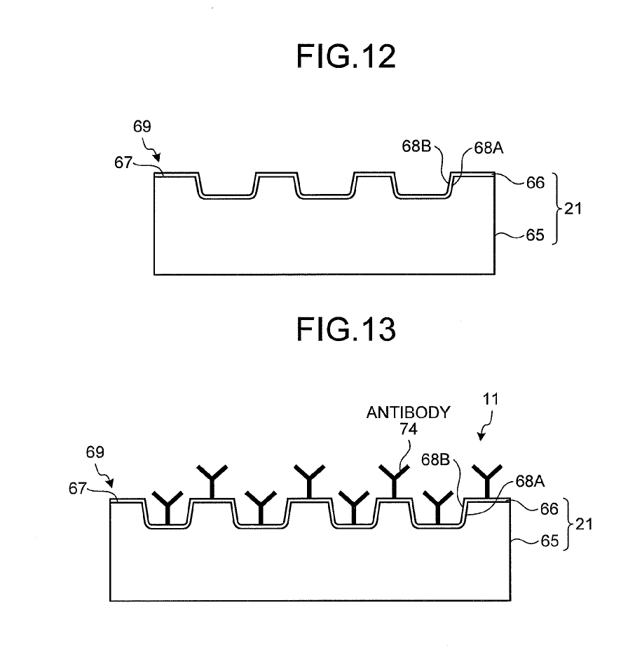

When the resin P is a cycloolefin-based polymer, the die DI is heated to about 160° C. and is pressed with pressure of about 12 MPa for a predetermined time. It is preferable to release the die when the surface temperature of the die DI becomes about 60° C. After the photonic crystal 65 is manufactured, the metal film 66 is formed on a surface, which was in contact with the die DI, by means of sputtering or a deposition apparatus, as illustrated in FIG. 12, and then the metal-film coated photonic crystal 21 is completed.

[Target Substance Capturing Material]

Next, the target substance capturing material that captures the target substance will be explained. The target substance is an object to be detected by the target substance detecting device 10, and may be any of a macromolecule such as a protein, an oligomer, or a low molecule. The target substance is not limited to a single molecule, and may be a complex made of a plurality of molecules. Examples of the target substance include a pollutant in the atmosphere, a toxic substance in water, and a biomarker in a human body. Among them, cortisol is preferable. Cortisol is a low-molecular substance having a molecular weight of 362 g/mol. The cortisol concentration in saliva increases when a human feels stress. Therefore, cortisol attracts attention as a substance with which the degree of stress felt by the human is evaluated. If the cortisol concentration contained in saliva of a human is measured using the cortisol as the target substance, the degree of stress can be evaluated. By evaluating the degree of stress, it can be determined whether a person to be measured is in a level of stress state leading to a mental disease such as depression.

The target substance capturing material is a material to bond with the target substance to capture the target substance. Here, bonding may be non-chemical bond, such as bonding by physisorption or Van der Waals force, in addition to the chemical bond. Preferably, the target substance capturing material specifically reacts with the target substance, and captures the target substance, and is preferable to be an antibody having the target substance as an antigen. The specific reaction means selective combination with the target substance in a reversible or irreversible manner to form a complex, and is not limited to a chemical reaction. Further, a substance to specifically react with the target substance capturing material may exist other than the target substance. Even if there is a substance to react with the target substance capturing material in a sample, other than the target substance, the target substance can be quantified when affinity of the substance is extremely smaller than that of the target substance. As the target substance capturing material, an antibody having the target substance as an antigen, an artificially manufactured antibody, a molecule configured from a substance that configures DNA such as adenine, thymine, guanine and cytosine, a peptide, or the like can be used. When the target substance is cortisol, the target substance capturing material is preferably a cortisol antibody.

To manufacture the target substance capturing material, a known method can be employed. For example, the antibody can be manufactured by a serum test, a hybridoma method, or a phage display method. The molecule configured from a substance that configures DNA can be manufactured by systematic evolution of ligands by exponential enrichment (SELEX method), for example. The peptide can be manufactured by a phage display method, for example. The target substance capturing material is not necessarily labeled with some sort of enzyme or isotope. However, the target substance capturing material may be labeled with enzyme or isotope.

In the present embodiment, the target substance capturing material is fixed to the reflection surface 69 of the metal-film coated photonic crystal 21 illustrated in FIG. 7. Examples of means for fixing the target substance capturing material to the reflection surface 69 of the metal-film coated photonic crystal 21 include chemical bond and physical bond methods such as covalent bond, chemisorption, and physisorption. These means can be appropriately selected according to a nature of the target substance capturing material. For example, when absorption is selected as the fixing means, an operation of the absorption is as follows. For example, a solution containing the target substance capturing material is dropped on the reflection surface 69 of the metal-film coated photonic crystal 21. The target substance capturing material is absorbed by the reflection surface 69 while the metal-film coated photonic crystal 21 is kept in a room temperature for a predetermined time, or is cooled/heated for a predetermined time, as needed.

The photonic crystal biosensor 11 allows an antibody (for example, a cortisol antibody), which is bonded only with a specific antigen (for example, cortisol), to be absorbed by (fixed to) the surface of the reflection surface 69 of the metal-film coated photonic crystal 21 in advance. Accordingly, the photonic crystal biosensor 11 can detect the specific antigen. This uses various optical characteristics of the photonic crystal 65, and biological reaction/chemical reaction occurring on the surface or in the vicinity of the surface of the photonic crystal 65, for example, an antigen/antibody reaction in which the specific antigen reacts only with the specific antibody.

The photonic crystal biosensor 11 may be constituted such that a blocking agent (protecting substance) is fixed on the reflection surface 69 to which the antibody as the target substance capturing material is fixed. The blocking agent is fixed before the target substance is brought to come in contact with the photonic crystal biosensor 11. The surface of the reflection surface 69 of the photonic crystal 65 is typically super-hydrophobic. Therefore, impurities other than the antibody as the target substance capturing material may be absorbed by the reflection surface 69 due to hydrophobic interaction. In addition, the optical characteristics of the photonic crystal 65 are substantially influenced by the surface state. Therefore, it is preferable that the impurities are not absorbed by the reflection surface 69 of the photonic crystal 65. The fixation of the blocking agent to the reflection surface 69 of the photonic crystal 65 improves the detection accuracy of the reflected light.

Therefore, it is preferable to fix the blocking agent in advance so that the impurities and the like are not fixed to a portion other than the portion where the antibody as the target substance capturing material is absorbed by (fixed to) the reflection surface 69 of the photonic crystal 65. To absorb the blocking agent in advance, the blocking agent is brought to come in contact with the surface of the photonic crystal 65. As the blocking agent, skim milk, bovine serum albumin (BSA), or the like can be used.

FIGS. 13 to 16 are diagrams for explaining a principle of the photonic crystal biosensor. A basic principle that the photonic crystal biosensor 11 detects the antigen as the target substance and the concentration will be explained with reference to the drawings. This principle is applicable in second and third embodiments explained below. Typically, the photonic crystal biosensor 11 detects a small amount of a protein or a low-molecular substance, using optical characteristics of the photonic crystal 65, and various biological reaction/chemical reaction occurring on the surface or in the vicinity of the surface of the photonic crystal 65, for example, an antigen/antibody reaction in which the specific antigen reacts only with the specific antibody. The photonic crystal biosensor 11 then uses a surface plasmon resonance phenomenon of when the reflection surface 69 of the metal-film coated photonic crystal 21 is irradiated with light having a specific wavelength and/or a phenomenon in which the extreme value of the wavelength of the reflected light is shifted due to a local surface plasmon resonance phenomenon.

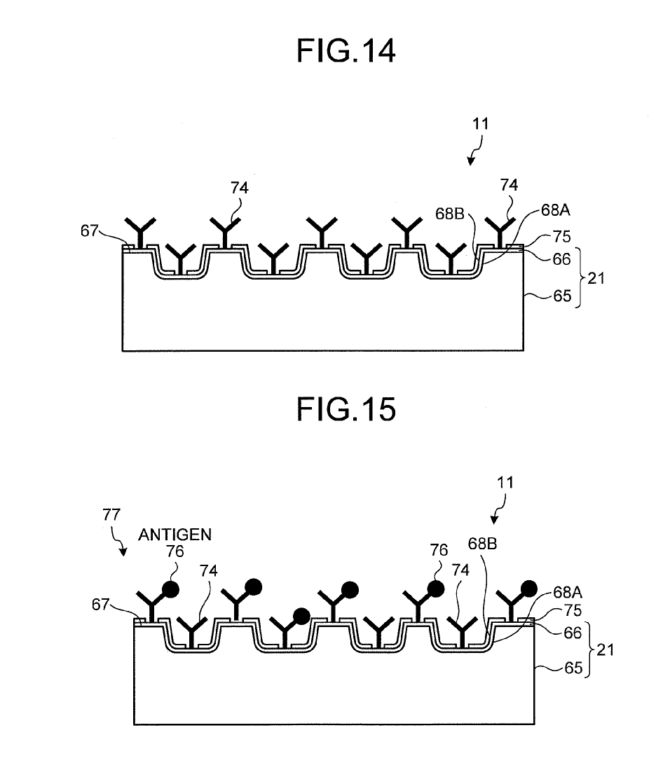

As illustrated in FIG. 13, an antibody (target substance capturing material) 74 is fixed to the surface of the reflection surface 69 of the metal-film coated photonic crystal 21 by absorption. Next, as illustrated in FIG. 14, a blocking agent (protecting substance) 75 is absorbed in advance by a portion of the reflection surface 69 other than the portion where the antibody 74 is absorbed, that is, the reflection surface 69 other than the portion where the antibody 74 is absorbed. Accordingly, the impurities and the like are not absorbed by a portion other than the portion of the reflection surface 69 where the antibody 74 is absorbed. Next, as illustrated in FIG. 15, an antigen (target substance) 76 is brought to come in contact with the photonic crystal biosensor 11 in which the antibody 74 and the blocking agent 75 are absorbed, and an antigen/antibody reaction is performed. A complex 77 in which the antigen 76 is captured by the antibody 74 is fixed to the reflection surface 69.

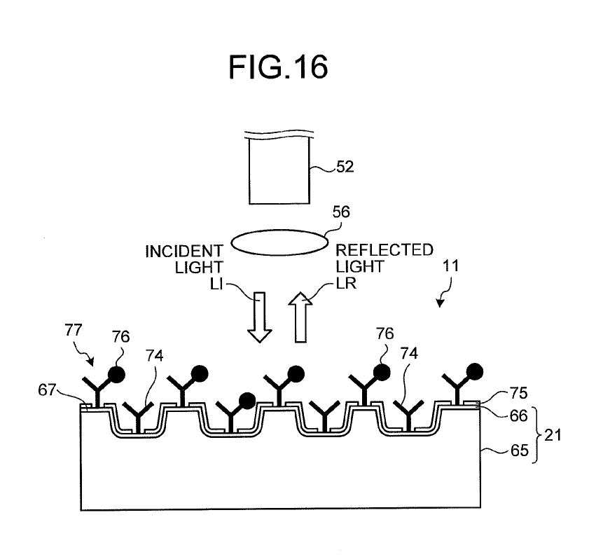

Next, the photo-detection section 12 illustrated in FIG. 1 irradiates the reflection surface 69 of the metal-film coated photonic crystal 21 with light (incident light) LI having a specific wavelength, in parallel light, in a state where the antigen 76 is captured on the reflection surface 69 of the photonic crystal 65, as illustrated in FIG. 16. Then, the photo-detection section 12 illustrated in FIG. 1 detects reflected light LR reflected on the reflection surface 69, and obtains the wavelength of the extreme value of the reflected light LR. Then, the processing unit 13 illustrated in FIG. 1 obtains the wavelength in the extreme value of the intensity of the reflected light LR and the shift amount of the wavelength in the extreme value of the intensity, detects existence/non-existence of the antigen 76 captured on the reflection surface 69 of the metal-film coated photonic crystal 21, and obtains the concentration of the antigen 76. The photonic crystal biosensor 11 can change the substance to be detected, that is, various types of biological substances such as a protein, or a type of a low-molecular weight substance, by changing a type of a combination of the antibody 74 and the antigen 76, based on such a principle.

In the photonic crystal biosensor 11, when the antigen 76 is captured by the antibody 74 fixed to the reflection surface 69, the state of the reflection surface 69 is changed, and the reflected light LR is changed. The photonic crystal biosensor 11 outputs an optical physical amount. The physical amount correlates with the change of the surface state in the reflection surface 69 of the metal-film coated photonic crystal 21, and correlates with the amount of the complex 77 that is formed such that the antigen 76 is captured by the antibody 74 fixed to the reflection surface 69. The optical physical amount is, for example, the shift amount of the wavelength with which the intensity of the reflected light LR becomes the extreme value, the amount of change of the reflectance of light, the shift amount of the wavelength with which the reflectance of light becomes the extreme value, the amount of change of the intensity of the reflected light LR or of the extreme value of the intensity of the reflected light LR, and the like. In the present embodiment, the shift amount of the wavelength with which the intensity of the reflected light LR or the reflectance of light becomes the extreme value is used.

To output the optical physical amount, the following processes are performed, for example. Light is vertically incident on the reflection surface 69 of the metal-film coated photonic crystal 21, and the reflected light LR is detected. The light can be incident on the reflection surface 69 of the metal-film coated photonic crystal 21 with an angle with respect to a perpendicular line of the reflection surface 69 of the metal-film coated photonic crystal 21, and the reflected light LR can be detected. By detection of the reflected light LR, the target substance detecting device 10 illustrated in FIG. 1 can be made compact. When vertically incident and vertically reflected light is detected, it is preferable to cause the light to be incident, using a bifurcated optical fiber, to detect the reflected light LR. This structure will be explained below.

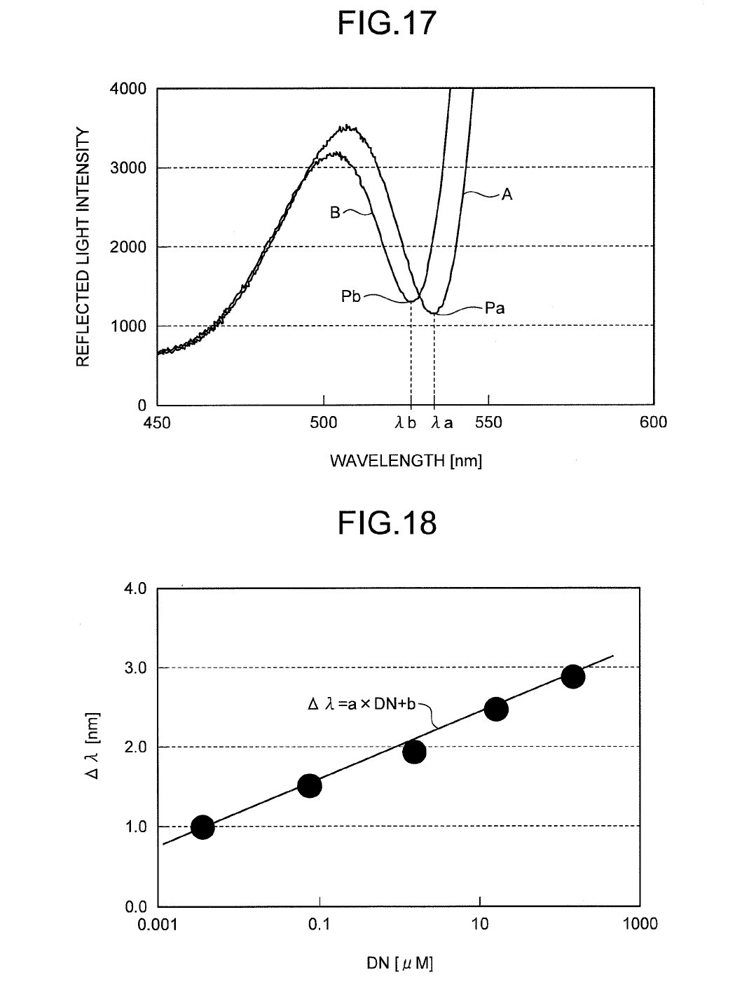

FIG. 17 is a diagram illustrating a relationship between the intensity of the extreme value of the reflected light and the wavelength. FIG. 17 illustrates reflection light intensity with respect to the wavelength (spectrum) of the reflected light. B in FIG. 17 illustrates a relationship between the reflected light intensity and the wavelength of a case where only the antibody 74 is absorbed by the metal film 66 of the reflection surface 69 of the metal-film coated photonic crystal 21. A of FIG. 17 illustrates a relationship between the reflected light intensity and the wavelength of a case where the antigen 76 is captured by the antibody 74 fixed to the reflection surface 69 of the metal-film coated photonic crystal 21. In both cases, extreme values (minimum values) Pa and Pb of the reflected light intensity are obtained between 550 nm and 500 nm of the wavelength. The wavelengths of that time are λb and λa (λb<λa). As illustrated in FIG. 15, when the antigen 76 is captured by the antibody 74 fixed to the surface of the metal film 66 that forms the reflection surface 69, the wavelength of the extreme value (minimum value) Pa is shifted to the larger λa, compared with the case where only the antibody 74 is absorbed by the metal film 66. In the present embodiment, the target substance is detected using the shift amount (a wavelength shift amount) Δλ (λa−λb) of the wavelength.

FIG. 18 is a diagram illustrating a relationship between a wavelength shift amount in the extreme value of the intensity of the reflected light, and the concentration of avidin fixed to the reflection surface of the photonic crystal, using biotin. As a result illustrated in FIG. 18, a wavelength shift amount Δλ in the extreme value (minimum value) of the reflected light intensity, of when biotin is fixed to the reflection surface 69 of the metal-film coated photonic crystal 21, as the target substance capturing material, and avidin having different concentration is dropped as the target substance, is obtained. The wavelength shift amount Δλ is an amount of change (an increase amount) from the wavelength in the extreme value (minimum value) of the reflected light intensity of when the reflection surface 69 of the metal-film coated photonic crystal 21 is only the metal film 66. As illustrated in FIG. 18, the wavelength shift amount Δλ increases as the concentration DN of avidin as the target substance increases. It has been found that the wavelength shift amount Δλ and the concentration DN of the dropped target substance have correlation. The relationship thereof can be approximated by a linear expression of Δλ=a×DN+b (a and b are constants). In the present embodiment, by obtaining the wavelength shift amount Δλ, the concentration of the target substance captured on the reflection surface 69 of the metal-film coated photonic crystal 21 is obtained. The above-described example is a case where biotin is used as the target substance capturing material, and avidin is used as the target substance. However, a similar result can be obtained in a case where cortisol is used as the target substance, and the cortisol antibody is used as the target substance capturing material.

[Photo-Detection Section]

Next, the photo-detection section 12 illustrated in FIG. 1 will be explained. The photo-detection section 12 illustrated in FIG. 1 includes a light source 51, a measuring probe 52, a photo-detection device 53, a first optical fiber 54, a second optical fiber 55, and a collimating lens 56. The light source 51 and the measuring probe 52 are optically connected by the first optical fiber 54. The measuring probe 52 and the photo-detection device 53 are optically connected by the second optical fiber 55.

A control device connected with the light source 51, the photo-detection device 53, and the like, and which controls the light source 51 and processes a signal from the photo-detection device 53 may be provided, as needed.

As illustrated in FIG. 16, the first optical fiber 54 illustrated in FIG. 1 guides the light from the light source 51 illustrated in FIG. 1 to the measuring probe 52, from which the light from the light source 51 irradiates the reflection surface 69 of the metal-film coated photonic crystal 21 included in the photonic crystal biosensor 11. The collimating lens 56 causes the light emitted from the first optical fiber 54 and irradiating from the measuring probe 52 to be parallel light, and irradiates the reflection surface 69 of the photonic crystal 65 with the parallel light as incident light LI. The second optical fiber 55 receives the light reflected on the reflection surface 69 of the metal-film coated photonic crystal 21, as the reflected light LR, and guides the reflected light LR to the photo-detection device 53 illustrated in FIG. 1. The type of the collimating lens 56 is not especially limited. However, for example, an antireflection film having a nanostructure can be used. The photo-detection device 53 is a device for detecting light, including a light receiving element such as a phototransistor or a charge coupled device (CCD).

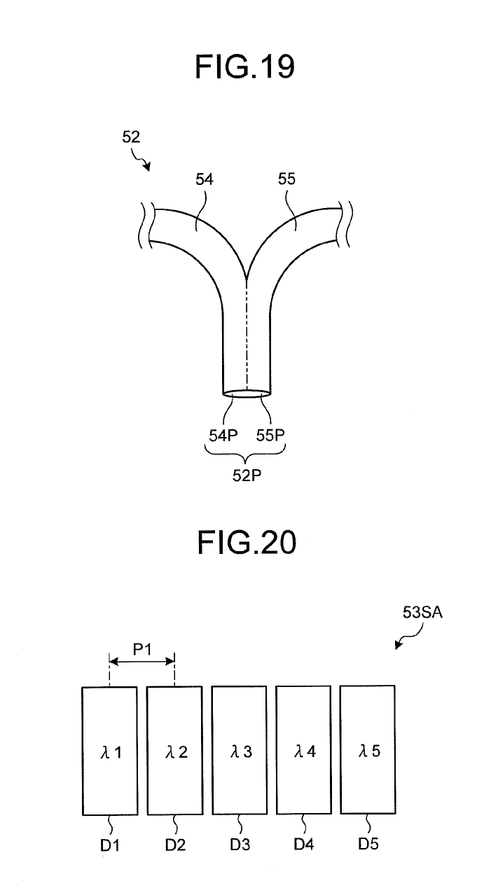

FIG. 19 is a diagram illustrating a structure of a measuring probe included in the photo-detection section illustrated in FIG. 1. In the measuring probe 52, the first optical fiber 54 and the second optical fiber 55 are joined. In the measuring probe 52, an emission surface 54P of the light of the first optical fiber 54 and an incident surface 55P of the reflected light LR of the second optical fiber 55 are arranged on the same surface (incident/emission surface) 52P. As explained above, in the measuring probe 52, the first optical fiber 54 and the second optical fiber 55 are integrated at an emission side (an emission surface 54P side) of the first optical fiber 54 and an incident side (an incident surface 55P side) of the second optical fiber 55. The measuring probe 52 allows the light to be incident and detects the reflected light LR, using the first optical fiber 54 and the second optical fiber 55.

Since the measuring probe 52 has such a structure, the measuring probe 52 can emit the incident light LI irradiating the reflection surface 69 of the photonic crystal 65, and receive the reflected light LR from the reflection surface 69, respectively, to and from an approximately the same position. The measuring probe 52 is caused to have the above-described structure, and the light from the measuring probe 52 is caused to be the parallel light using the collimating lens 56, so that the photo-detection section 12 allows the incident light LI of the parallel light to be vertically incident on the reflection surface 69. Further, the photo-detection section 12 can receive the reflected light LR vertically reflected on the reflection surface 69. Accordingly, the measuring probe 52 can minimize a decrease in the reflected light intensity, and can mainly detect 0-order light component of the reflected light LR. As a result, the processing unit 13 can obtain accurate information of the reflection surface 69 of the metal-film coated photonic crystal 21. Therefore, the detection accuracy of the target substance and the measurement accuracy of the concentration are improved. A technique of detecting the reflected light LR is not limited to the above-described measuring probe 52. For example, a half mirror is arranged between the collimating lens 56 and the reflection surface 69, and the reflected light LR is divided by the half mirror, and guided through the second optical fiber 55 to the photo-detection device 53. The collimating lens 56 may include an antireflection film. Accordingly, an influence of the reflected light from the collimating lens 56 is decreased. Therefore, a noise generated at the time of measurement can be decreased.

The photo-detection device 53 illustrated in FIG. 1 includes a spectrometer that detects a light spectrum of the reflected light LR. As the spectrometer, there are a monochromator and a multichannel spectrometer. In the present embodiment, the multichannel spectrometer is employed from the viewpoint of fast detection speed. The multichannel spectrometer is a device that disperses the incident light into a plurality of different wavelength regions, using a prism, grating, and the like, and detects a spectrum with photo-detection elements arrayed in an array manner. The multichannel spectrometer can obtain measurement result for each pixel of the photo-detection elements arrayed in an array manner, at a pitch of a specific wavelength width. A product of division of a measurement range of one spectrometer by the number of pixels is called pixel resolution. The pixel resolution is resolution of the wavelength of the light which the spectrometer can detect.

In the spectrometer in which the photo-detection elements are arrayed in an array manner, as a method of reading a signal from the photo-detection elements arrayed in an array manner, there are a charge coupled device (CCD) system, and a complementary metal oxide semiconductor (CMOS) system. In the present embodiment, either system may be employed. As the photo-detection elements, photodiodes, avalanche photodiodes, photomultiplier tubes, or the like may be arrayed in an arrayed manner.

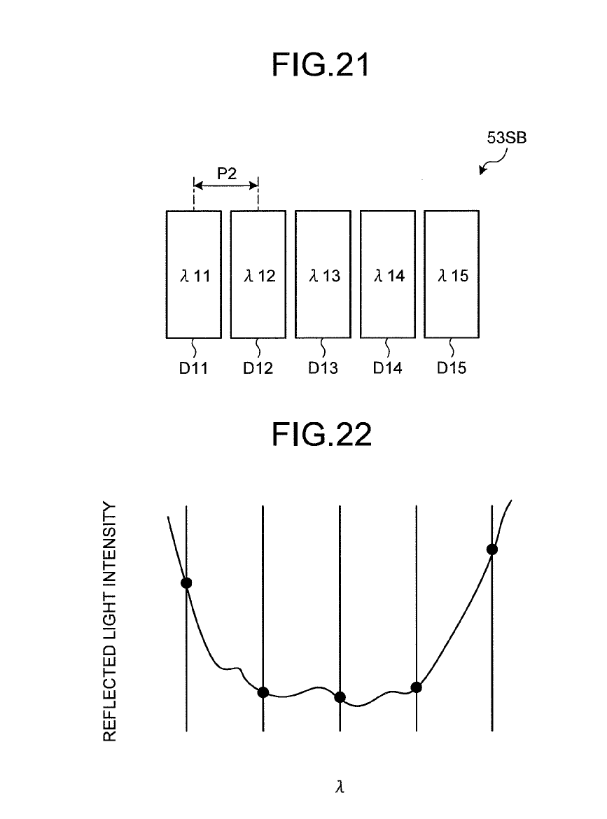

FIGS. 20 and 21 are diagrams illustrating pixels of a spectrometer included in a photo-detection device. A spectrometer 53SA illustrated in FIG. 20 includes five pixels D1, D2, D3, D4, and D5. A spectrometer 53SB illustrated in FIG. 21 also includes five pixels D11, D12, D13, D14, and D15. The pixels D1, D2, D3, D4, and D5 of the spectrometer 53SA respectively detect light having wavelengths λ1, λ2, λ3, λ4, and λ5 (λ1<λ2<λ3<λ4<λ5). The pixels D11, D12, D13, D14 and D15 of the spectrometer 53SB respectively detect light having wavelengths λ11, λ12, λ13, λ14, and λ15 (λ11<λ12<λ13<λ14<λ15).

The wavelengths λ1, λ2, λ3, λ4, and λ5 become large by 1 μm in this order, and the wavelengths λ11, λ12, λ13, λ14, and λ15 become large by 0.1 μm in this order. Therefore, pixel resolution P1 of the spectrometer 53SA is 1 nm, and pixel resolution P2 of the spectrometer 53SB is 0.1 nm. When the number pixels (pixel number) is the same between the spectrometer 53SA and the spectrometer 53SB (the pixel number is five in the example of FIGS. 20 and 21, and is the same), the spectrometer 53SB having the pixel resolution P2 of 0.1 nm is preferable in order to calculate a peak position of a spectrum because the form of a spectrum peak can be more accurately measured. Therefore, the pixel resolution having a smaller numerical value is defined to have higher resolution.

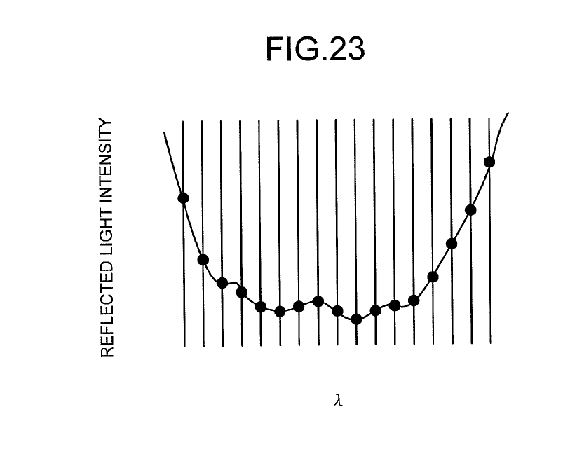

FIG. 22 is a diagram illustrating an example of a spectrum of reflected light detected by the spectrometer illustrated in FIG. 20. FIG. 23 is a diagram illustrating an example of a spectrum of reflected light detected by the spectrometer illustrated in FIG. 21. In FIGS. 22 and 23, the horizontal axes represent the wavelength A, and the vertical axes represent the reflected light intensity. The photo-detection device 53 illustrated in FIG. 1 may include the spectrometers 53SA and 53SB having the different pixel resolution or may include a spectrometer having variable pixel resolution. Accordingly, the photo-detection device 53 can find out a rough peak position in a wide measuring range (the pixel resolution is low), and detects an accurate peak position in a narrow measuring range (the pixel resolution is high). When the photo-detection device 53 includes the spectrometer 53SA and the spectrometer 53SB, the photo-detection device 53 finds out a rough peak position as illustrated in FIG. 22 in a wide measuring range, that is, with the spectrometer 53SA having relatively low pixel resolution P1. The photo-detection device 53 finds out an accurate peak position as illustrated in FIG. 23 in a narrow measuring range, that is, with the spectrometer 53SB having relatively high pixel resolution P2. In the target substance detecting device 10 illustrated in FIG. 1, the processing unit 13 obtains the wavelength of the extreme value of the reflected light, using the spectrometer 53SA as a first spectrometer, and then obtains the wavelength of the extreme value of the reflected light in a range of the wavelength of the extreme value obtained with the spectrometer 53SA, using the spectrometer 53SB as a second spectrometer. Accordingly, both of the wide measuring range and the accurate peak position detection can be achieved.

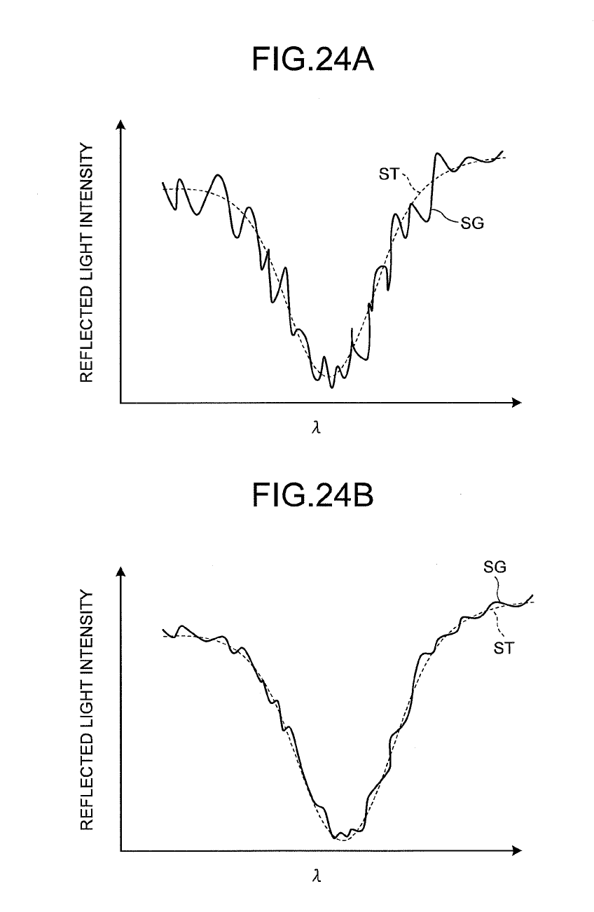

FIG. 24A is a diagram illustrating an example of a spectrum of reflected light in a case where a photo-detection element included in a spectrometer is not cooled. FIG. 24B is a diagram illustrating an example of a spectrum of reflected light in a case where a photo-detection element included in a spectrometer is cooled. In FIGS. 24A and 24B, the horizontal axes represent the wavelength A, and the vertical axes represent the reflected light intensity. In both drawings, the dotted lines ST represent a spectrum of actual reflected light, and the solid lines SG represent a detection result of a spectrum of reflected light detected by the spectrometer. When the photo-detection element included in the spectrometer generates heat, a noise due to the heat is generated, like the detection result SG illustrated by the solid line of FIG. 24A. It is preferable to cool the photo-detection element in order to detach the noise. To cool the photo-detection element, the noise due to heat can be decreased, like the detection result SG illustrated by the solid line of FIG. 24B. To cool the photo-detection element, for example, a Peltier element can be used.

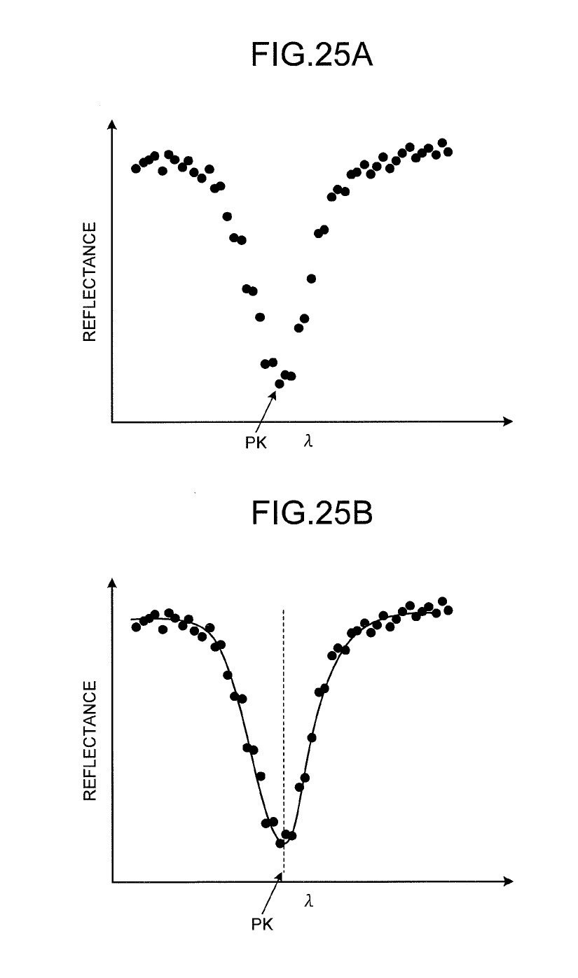

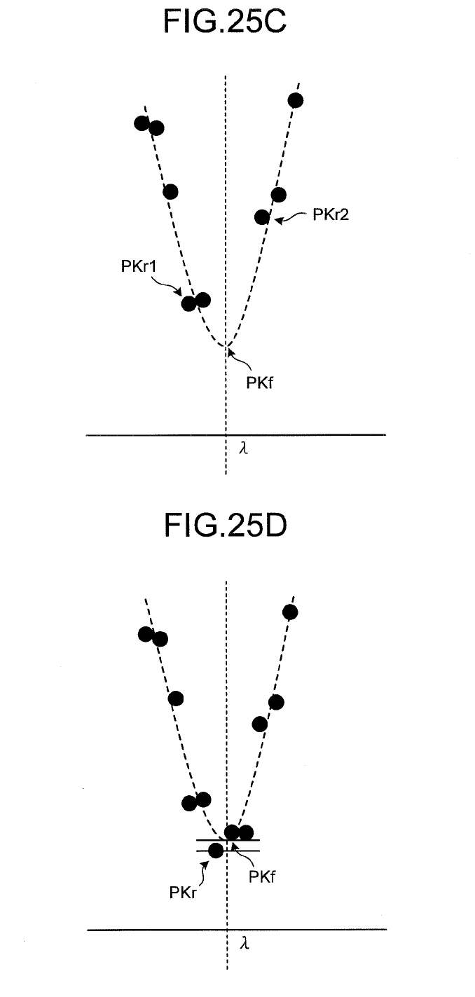

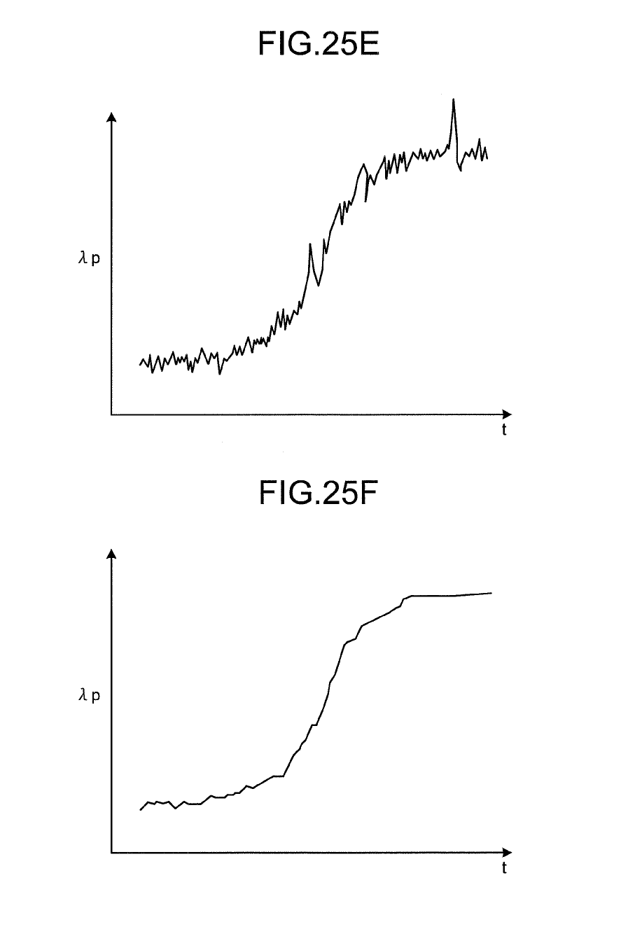

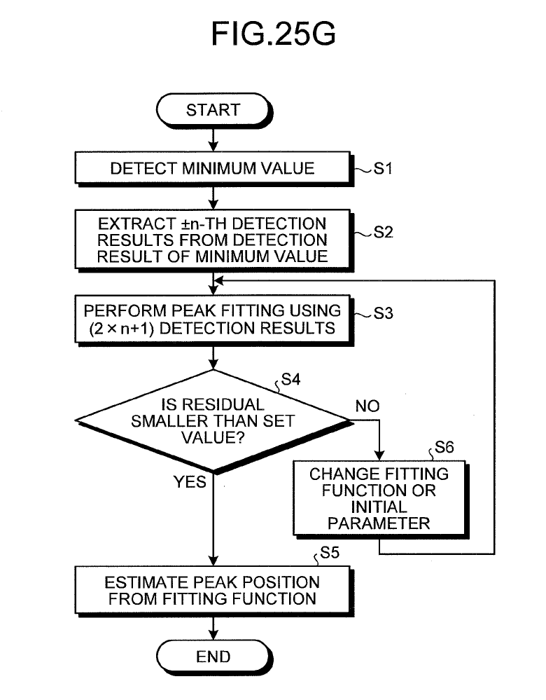

FIG. 25A is a diagram illustrating an example of a spectrum of reflected light detected by a photo-detection element included in a spectrometer. FIG. 25B is a diagram for explaining an example of obtaining a peak position by performing data fitting of a result illustrated in FIG. 25A. In FIGS. 25A and 25B, the vertical axes represent the reflectance, and the horizontal axes represent the wavelength λ. As illustrated in FIG. 25A, when the photo-detection device 53 detects a peak position PK of the reflected light, the resolution cannot be made higher than the pixel resolution of the spectrometers 53SA and 53SB illustrated in FIGS. 20 and 21. Therefore, as illustrated by the dotted line of FIG. 25B, data fitting using an arbitrary function is performed for the detection result of the photo-detection device 53, so that the peak position PK can be obtained with higher resolution than the pixel resolution of the spectrometers 53SA and 53SB. The wavelength of the reflected light in the peak position PK corresponds to the wavelength of the reflected light in the extreme value. That is, the peak position PK becomes the position of the extreme value. If the peak position PK can be accurately obtained, the wavelength of the reflected light in the extreme value can be accurately obtained. As the arbitrary function, an n-order function (n is an integer of two or more), a Lorentz function, a Gaussian function, a Voigt function, a beta function, or a function of a combination of a plurality of the aforementioned functions can be used.

FIGS. 25C and 25D are diagrams illustrating a peak position obtained from a detection result of a photo-detection device, and a peak position obtained by performing data fitting of a detection result of a photo-detection device. The detection results of the photo-detection device 53 are illustrated by the black dots in FIGS. 25C and 25D. In the example illustrated in FIG. 25C, when a peak position is obtained from the detection result of the photo-detection device 53, the peak position becomes a position PKr1. However, in the example illustrated in FIG. 25C, it is estimated that there is a peak position between the position PKr1 and a position PKr2, from change of the detection result. A peak position PKf obtained by performing fitting, that is, peak fitting in the present embodiment, of the detection result of the photo-detection device 53, that is, the detection results of the spectrometers 53SA and 53SB in the present embodiment, exists between the position PKr1 and the position PKr2. In this way, by performing the data fitting of the detection results, higher resolution than the pixel resolution of the spectrometers 53SA and 53SB can be realized. Therefore, the more probable peak position PKf, that is, the wavelength of the reflected light in the extreme value can be obtained. In the present embodiment, the wavelength of the extreme value may just be obtained by performing fitting of at least one of the detection result of the spectrometer 53SA as the first spectrometer and the detection result of the second spectrometer 53SB, by a function.

In the example illustrated in FIG. 25D, when a peak position is obtained from the detection result of the photo-detection device 53, the peak position becomes a position PKr. However, in the example illustrated in FIG. 25D, there is a possibility that the position PKr includes an error, from change of the detection result. Higher resolution than the pixel resolution of the spectrometers 53SA and 53SB can be realized by performing data fitting of the detection result. Therefore, the more probable peak position PKf, that is, the wavelength of the reflected light in the extreme value can be obtained.

FIG. 25E is a diagram illustrating temporal change of a peak wavelength obtained from a detection result of a photo-detection device. FIG. 25F is a diagram illustrating temporal change of a peak wavelength obtained by performing peak fitting of a detection result of a photo-detection device. As illustrated in these drawings, it is found that the temporal change of a peak wavelength λp obtained by peak fitting becomes smoother than the temporal change of a peak wavelength λp obtained from the detection result of the photo-detection device 53.

FIG. 25G is a flowchart illustrating each processing of peak fitting. The peak fitting is executed by the processing unit 13 of the target substance detecting device 10 illustrated in FIG. 1. In step S1, the processing unit 13 acquires the detection result of the photo-detection device 53, and extracts the detection result having the minimum value from a detection result group around a bottom peak. Next, in step S2, the processing unit 13 extracts up to ±n-th detection results, based on the detection result having the minimum value. n is an integer larger than 1.

In step S3, the processing unit 13 performs peak fitting, using (2×n+1) detection results. In the peak fitting, the above-described arbitrary function is used. The processing proceeds to step S4, and the processing unit 13 calculates a residual between a curved line obtained by the peak fitting, and the detection result of the photo-detection device 53, and when the calculated residual is smaller than a set value determined in advance (Yes in step S4), the processing proceeds to step S5. In step S5, the processing unit 13 estimates the peak position from the fitting function, that is the function used in the peak fitting. In step S4, when the calculated residual is equal to or more than the set value determined in advance (No in step S4), the processing proceeds to step S6. In step S6, the processing unit 13 changes at least one of the fitting function or an initial parameter, and executes steps S3 and S4. The n-order function (n is an integer of two or more), the Lorentz function, the Gaussian function, the Voigt function, and the beta function, which have been exemplarily explained as the fitting function, are on a par. A function closest to the detection result group of an object to be subjected to the peak fitting, that is, a function having a shape with the smallest residual is the function most suitable for the case.

[Liquid Handling Section]

Next, the liquid handling section 14 illustrated in FIG. 1 will be explained. The liquid handling section 14 illustrated in FIG. 1 includes a first container 30 that holds a liquid L such as the solution containing the target substance capturing material, a pump 31 as a liquid sending device, and a second container 32 that stores the liquid L discharged from the photonic crystal biosensor 11. The pump 31 is controlled by the processing unit 13 illustrated in FIG. 1. In the first container 30, the liquid supply pipe 25 is inserted. The liquid discharge pipe 26 is connected with an inlet of the pump 31. A discharge pipe 33 connected with an outlet of the pump 31 is inserted in the second container 32. The pump 31 sucks the liquid L from the liquid discharge pipe 26, thereby to supply the liquid L in the first container 30 to the opening portion 23P of the photonic crystal biosensor 11. When the measurement is terminated, the pump 31 sucks the liquid L in the opening portion 23P of the photonic crystal biosensor 11, and discharges the liquid L through the discharge pipe 33 to the second container 32. As explained above, the liquid handling section 14 supplies the liquid L such as the solution containing the target substance capturing material to the opening portion 23P of the photonic crystal biosensor 11, with the pump 31.

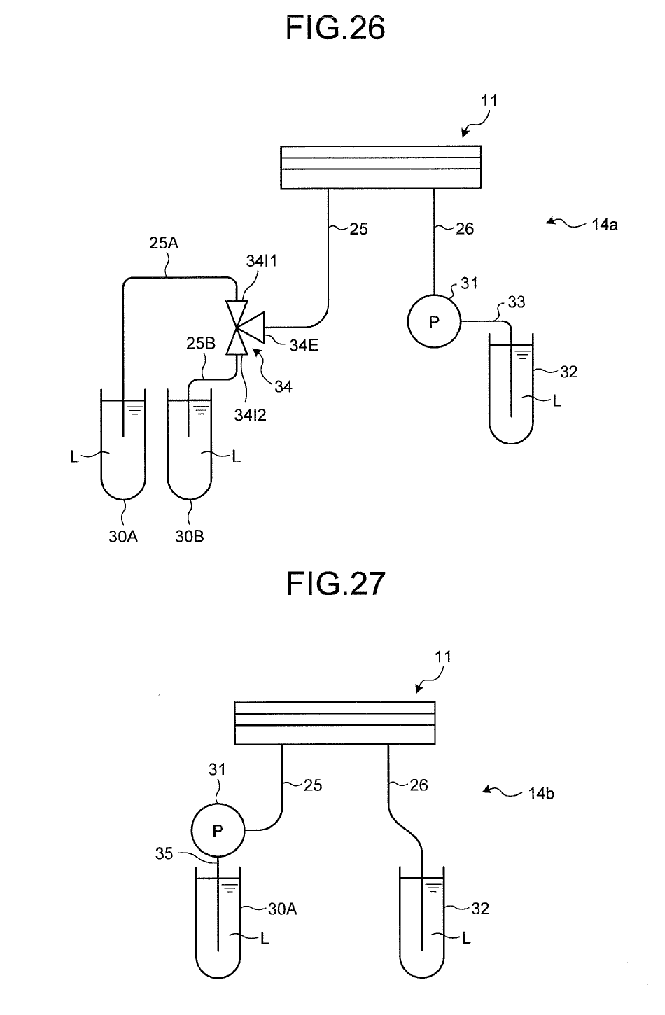

FIGS. 26 and 27 are diagrams illustrating modifications of a liquid handling section. A liquid handling section 14a illustrated in FIG. 26 includes a first container 30A, a pump 31, a second container 30B, a three-way valve 34, and a third container 32. A first liquid supply pipe 25A and a second liquid supply pipe 25B are respectively connected with a first inlet 341 and a second inlet 3412 that are two inlets of the three-way valve 34. The first liquid supply pipe 25A is inserted in the first container 30A, and the second liquid supply pipe 25B is inserted in the second container 30B. A liquid supply pipe 25 is connected with an outlet 34E of the three-way valve 34. The three-way valve 34 can switch a first state in which the first inlet 3411 and the outlet 34E are connected, and a second state in which the second inlet 3412 and the outlet 34E are connected. In the present embodiment, the control device 13 illustrated in FIG. 1 controls the three-way valve 34 to switch the first state and the second state. When the pump 31 is driven in the first state of the three-way valve 34, the liquid L in the first container 30A is supplied to an opening portion 23P of a photonic crystal biosensor 11. When the pump 31 is driven in the second state of the three-way valve 34, the liquid L in the second container 30B is supplied to the opening portion 23P of the photonic crystal biosensor 11. If different types of liquids L are held in the first container 30A and the second container 30B, the different liquids L can be supplied to the opening portion 23P of the photonic crystal biosensor 11, by switching the three-way valve 34. As explained above, the liquid handling section 14a can simplify the work to supply the plurality of liquids L to the opening portion 23P of the photonic crystal biosensor 11.

A liquid handling section 14b illustrated in FIG. 27 is similar to the liquid handling section 14 illustrated in FIG. 1, but is different in that the liquid handling section 14b supplies a liquid L to an opening portion 23P of a photonic crystal biosensor 11 with positive pressure, while the liquid handling section 14 supplies the liquid L with negative pressure. Therefore, a suction tube 35 connected with an inlet of a pump 31 is inserted in a first container 30A, and a liquid supply pipe 25 is connected with an outlet of a pump 31. A liquid discharge pipe 26 is inserted in a third container 32. When the pump 31 is driven, the liquid L sucked by the pump 31 from the first container 30A is ejected through the outlet of the pump 31, and then passes through the liquid supply pipe 25, and is supplied to the opening portion 23P of the photonic crystal biosensor 11.

[Modification of Photonic Crystal Biosensor]

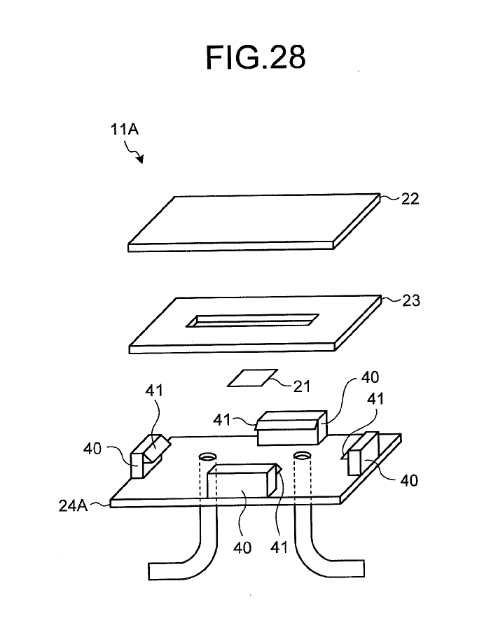

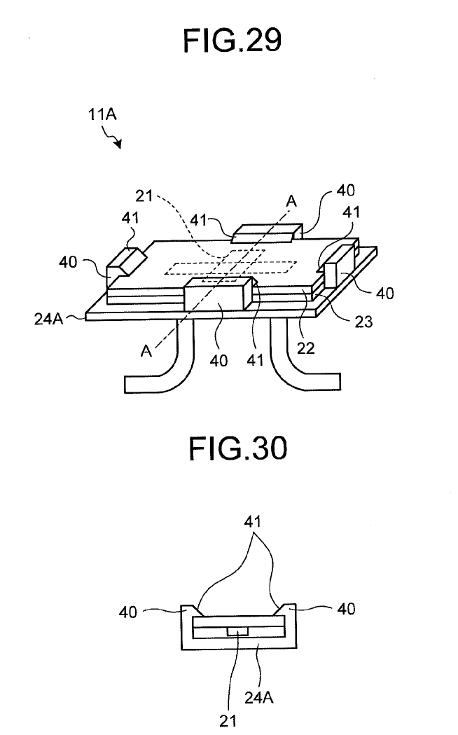

FIGS. 28 to 30 are diagrams illustrating a first modification of a photonic crystal biosensor. A photonic crystal biosensor 11A has a similar structure to the above-described photonic crystal biosensor 11, but is different in that a supporting member 24A includes a plurality of claws 41 to engage with a holding member 23 that puts a metal-film coated photonic crystal 21 in between the holding member 23 and the supporting member 24A, at a side where the metal-film coated photonic crystal 21 is placed. Other structures are similar to those of the above-described photonic crystal biosensor 11. As illustrated in FIGS. 28 and 30, the plurality of claws 41 is provided on a surface of the supporting member 24A, where the metal-film coated photonic crystal 21 is placed, and in a tip portion of a supporting body 40 provided in an outer edge portion. The claw 41 has a triangular cross section, as illustrated in FIG. 30. In the photonic crystal biosensor 11A, after the metal-film coated photonic crystal 21 is placed on the supporting member 24A, the holding member 23 and the covering member 22 are fitted in the plurality of claws 41 in that order. The claws 41 engage with a surface of the covering member 22, thereby to put the metal-film coated photonic crystal 21 in between the holding member 23 and the supporting member 24, through the covering member 22 and the holding member 23. The photonic crystal biosensor 11A can fix the metal-film coated photonic crystal 21 without using the mounting tools 27 and 28 illustrated in FIG. 3. A distance between facing claws 41 becomes larger as the claws 41 are away from the supporting member 24A, as illustrated in FIG. 30. Accordingly, the holding member 23 and the covering member 22 can be easily fitted in the supporting member 24A on which the metal-film coated photonic crystal 21 is placed.

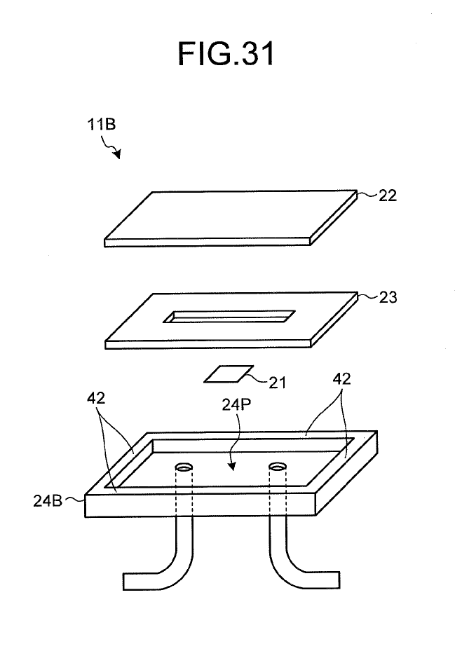

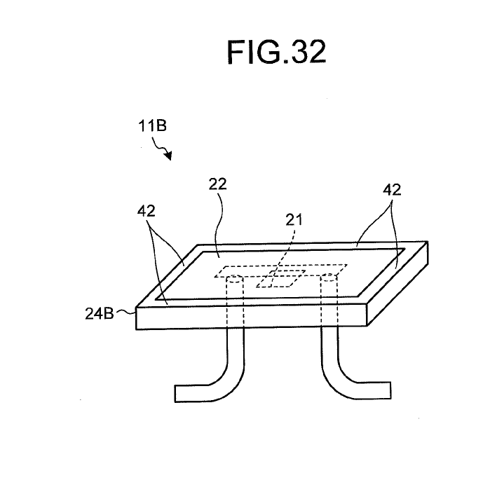

FIGS. 31 and 32 are diagrams illustrating a second modification of a photonic crystal biosensor. A photonic crystal biosensor 11B has a similar structure to the above-described photonic crystal biosensor 11. However, the photonic crystal biosensor 11B is different in that a supporting member 24B includes a portion that holds a holding member 23 and allows a covering member 22 that covers the holding member 23 to be fitted therein, at a side where a metal-film coated photonic crystal 21 is placed. Other structures are similar to those of the above-described photonic crystal biosensor 11. As illustrated in FIGS. 31 and 32, walls 42 are provided on a surface 24P, on which the metal-film coated photonic crystal 21 is placed, of a supporting member 24B and in outer edge portions thereof. The walls 42 hold the holding member 23, and the covering member 22 is fitted in the walls 42. The walls 42 rise from the outer edge portion of the surface 24P toward a thickness direction of the supporting member 24B. The walls 42 surround the surface 24P, on which the metal-film coated photonic crystal 21 is placed, of the supporting member 24B. The metal-film coated photonic crystal 21 is placed on a portion surrounded by the walls 42. The holding member 23 is mounted in the portion surrounded by the walls 42, so that the metal-film coated photonic crystal 21 is put in between the holding member 23 and the supporting member 24B. Under this state, the covering member 22 is mounted on a surface of the holding member 23. The dimension of the portion surrounded by the wall 42 is smaller than the dimension of an outer edge of the covering member 22. Therefore, the covering member is fixed to the walls 42 by being fitted in the walls 42. The photonic crystal biosensor 11B can fix the metal-film coated photonic crystal 21 without using the mounting tools 27 and 28 illustrated in FIG. 3.

The present embodiment and its modifications guide the liquid to the opening portion 23P included in the holding member 23 of the photonic crystal biosensor 11 or the like. Accordingly, the liquid in the opening portion 23P can be replaced in a state where the metal-film coated photonic crystal 21 is sandwiched between the supporting member 24 and the holding member 23. As a result, a measurement noise due to an error in mounting the metal-film coated photonic crystal 21 decreases. As a result, the detection sensitivity of the target substance can be improved. The configurations of the present embodiment and its modifications can be appropriately applied or combined in embodiments below.

### Second Embodiment

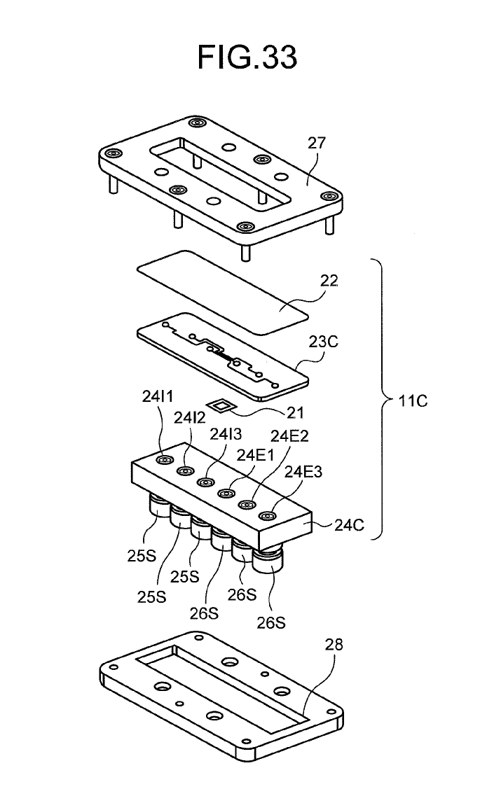

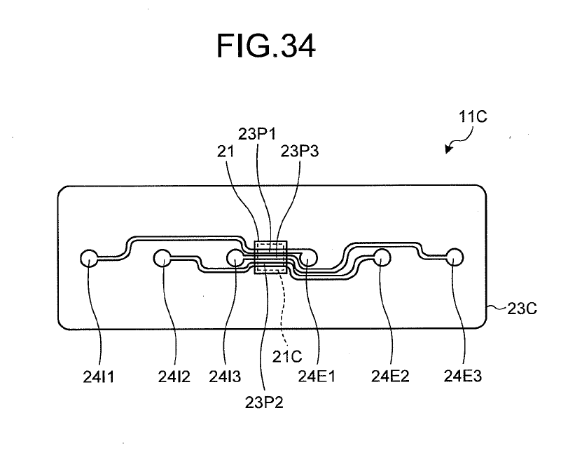

FIGS. 33 and 34 are diagrams illustrating a photonic crystal biosensor according to a second embodiment. The second embodiment is different from the first embodiment and its modifications in that a holding member includes a plurality of opening portions. Other structures are similar to those of the first embodiment and its modifications, and thus description of similar portions is omitted, as needed. A photonic crystal biosensor 11C includes a supporting member 24C, a holding member 23C, and a covering member 22. The holding member 23C includes a plurality of opening portions 23P1, 23P2, and 23P3 that overlap with a portion 21C that captures a target substance of a metal-film coated photonic crystal 21 placed on the supporting member 24C. The opening portions 23P1, 23P2, and 23P3 penetrate two largest facing planes of the holding member 23C as a plate member, as illustrated in FIG. 34. The opening portions 23P1, 23P2, and 23P3 are arranged in a groove manner, as illustrated in FIG. 34, and open to overlap the portion 21C that captures the target substance of the metal-film coated photonic crystal 21. The plurality of opening portions 23P1, 23P2, and 23P3 does not intersect with each other. In the present embodiment, the opening portions 23P1, 23P2, and 23P3 are arranged in parallel to the portion 21C that captures the target substance of the metal-film coated photonic crystal 21. The plurality of opening portions 23P1, 23P2, and 23P3 is not necessarily parallel to each other.

The supporting member 24C on which the metal-film coated photonic crystal 21 is placed includes a plurality of holes 24I1, 24I2, 24I3, 24E1, 24E2, and 24E3. The opening portions 23P1, 23P2, and 23P3 also overlap with the holes 24I1, 24I2, 24I3, 24E1, 24E2, and 24E3 of the supporting member 24C. Two of the holes 24I1, 24I2, 24I3, 24E1, 24E2, and 24E3 are open to one of the plurality of opening portions 23P1, 23P2, and 23P3, respectively, in a state where the metal-film coated photonic crystal 21 is put in between the holding member 23C and the supporting member 24C. To be specific, the holes 24I1 and 24E1 open to the opening portion 23P1, the holes 24I2 and 24E2 open to the opening portion 23P2, and the holes 24I3 and 24E3 open to the opening portion 23P3. The hole 24I1 supplies a liquid such as a solution that contains a target substance capturing material to the opening portion 23P1, the hole 2412 supplies the solution to the opening portion 23P2, and the hole 24I3 supplies the solution to the opening portion 23P3. The hole 24E1 discharges the liquid such as a solution that contains a target substance capturing material from the opening portion 23P1, the hole 24E2 discharges the liquid from the opening portion 23P2, and the hole 24E3 discharges the solution from the opening portion 23P3. Hereinafter, the holes 24I1, 24I2, and 24I3 are appropriately called liquid supply holes 24I1, 24I2, and 24I3, and the holes 24E1, 24E2, and 24E3 are called liquid discharge holes 24E1, 24E2, and 24E3. With such a configuration, the photonic crystal biosensor 11C can introduce the liquid to each of the opening portions 23P1, 23P2, and 23P3, and thus can evaluate different types of liquid with one metal-film coated photonic crystal 21.

In the introduction of the liquid to each of the opening portions 23P1, 23P2, and 23P3, the liquid discharge holes 24E1, 24E2, and 24E3 may be connected with an inlet of a pump, and the liquid may be introduced to the opening portions 23P1, 23P2, and 23P3, using negative pressure. In this case, the pumps may be provided corresponding to the respective opening portions 23P1, 23P2, and 23P3, or one pump may supply the liquid to the opening portions 23P1, 23P2, and 23P3, and discharges the liquid from the opening portions 23P1, 23P2, and 23P3. Further, the liquid supply holes 24I1, 24I2, and 24I3 may be connected with outlets of pumps, and the liquid may be introduced to the opening portions 23P1, 23P2, and 23P3, using positive pressure. In this case, the pumps are provided corresponding to the respective opening portions 23P1, 23P2, and 23P3.

It is difficult to finely control the shape of the metal-film coated photonic crystal 21 even if the metal-film coated photonic crystal 21 is manufactured by the same manufacturing process because the metal-film coated photonic crystal 21 has a microstructure. Therefore, variation occurs in each metal-film coated photonic crystal 21. The photonic crystal biosensor 11C can introduce the liquid to each of the opening portions 23P1, 23P2, and 23P3, and can calibrate the metal-film coated photonic crystal 21 at the same time of inspection. As a result, the photonic crystal biosensor 11C can realize highly accurate measurement. For example, a solution to be inspected and a standard solution having known characteristics (for example, the concentration and the like) are introduced to the portion 21C that captures the target substance of the metal-film coated photonic crystal 21 at the same time. The concentration of the standard solution is known in advance. Therefore, a calibration curve is obtained from a detection result of the standard solution and a detection result of the solution to be inspected, so that calibration of the metal-film coated photonic crystal 21 can be performed at the same time of the inspection. As a result, the photonic crystal biosensor 11C can highly accurately measure the concentration and the like of the target substance contained in the solution to be inspected. Further, a volume of a space surrounded by the opening portions 23P1, 23P2, and 23P3, the supporting member 24C, and the covering member 22 is smaller than a volume of a space surrounded by the opening portion 23P, the supporting member 24, and the covering member 22 in the first embodiment. Therefore, the amount of the liquid to be supplied to the opening portions 23P1, 23P2, and 23P3 can be small. Therefore, the present embodiment is especially preferable when an expensive liquid is used.

When the holding member 23C has two or more opening portions, the photonic crystal biosensor 11C can calibrate the metal-film coated photonic crystal 21. Therefore, it is preferable that the holding member 23C includes two or more opening portions. Further, to more accurately calibrate the metal-film coated photonic crystal 21, it is preferable to introduce a plurality of standard solutions, in addition to the solution to be inspected. Therefore, it is more preferable that the holding member 23C has three or more opening portions.

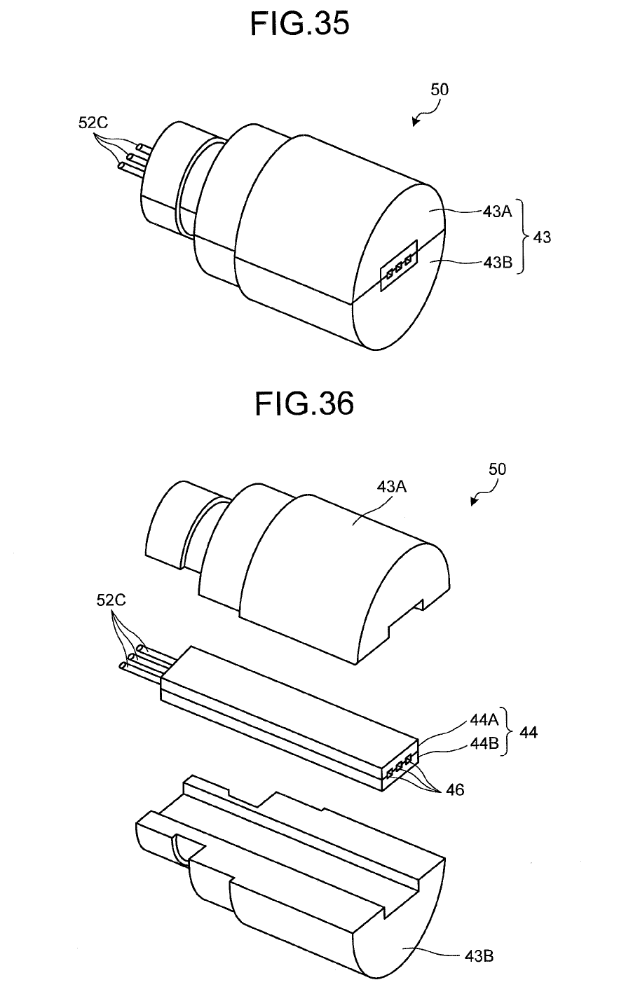

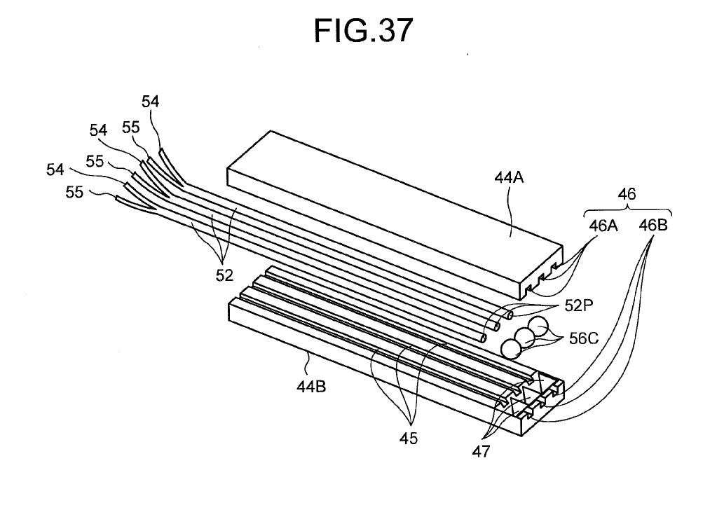

FIG. 35 is a perspective view illustrating a photo-detection unit according to the second embodiment. FIGS. 36 and 37 are exploded views of a photo-detection unit according to the second embodiment. A photo-detection unit 50 irradiates the portion 21C that captures the target substance of the metal-film coated photonic crystal 21 from the plurality of (three in the present embodiment) opening portions 23P1, 23P2, and 23P3 included in the holding unit 23C of the photonic crystal biosensor 11C with light, and receives reflected light. Therefore, the photo-detection unit 50 includes a plurality of measuring probes 52C, as illustrated in FIGS. 35 and 36.

The photo-detection unit 50 stores the plurality of measuring probes 52C in a casing 43, as illustrated in FIG. 35. The casing 43 is divided into a first casing 43A and a second casing 43B. As illustrated in FIG. 36, a holding unit 44 that houses and holds the plurality of measuring probes 52C is mounted inside the casing 43. The holding unit 44 is divided into a first member 44A and a second member 44B. As illustrated in FIGS. 36 and 37, the plurality of measuring probes 52C is arranged between the first member 44A and the second member 44B. A plurality of (three in the present embodiment) openings 46 for irradiating the portion 21C that captures the target substance of the metal-film coated photonic crystal 21 with light and receiving the reflected light is provided in one end portion of the holding unit 44. An interval of the plurality of openings 46 is the same as an interval of the plurality of opening portions 23P1, 23P2, and 23P3 in the portion 21C that captures the target substance of the metal-film coated photonic crystal 21. The measuring probe 52C is manufactured such that a first optical fiber 54 and a second optical fiber 55 are joined, and an emission surface of the light of the first optical fiber 54 and an incident surface of the second optical fiber 55 are arranged in the same incident/emission surface 52P, similarly to the measuring probe 52 illustrated in FIG. 15.

As illustrated in FIG. 37, collimating lenses 56C are arranged between the incident/emission surface 52P of the measuring probes 52 and the openings 46. The opening 46 is a combination of a notch 46A formed in one end portion of the first member 44A and a notch 46B formed in one end portion of the second member 44B. As illustrated in FIG. 37, the second member 44B includes a plurality of grooves 45 for holding the measuring probes 52C. The first member 44A also includes a plurality of grooves 45, similarly to the second member 44B. The measuring probe 52C is put in and held in the grooves 45 of the first member 44A and the second member 44B.

The collimating lens 56C is a spherical lens. As illustrated in FIG. 37, the second member 44B includes a plurality of recessed portions 47 for holding the collimating lenses 56C. The first member 44A also includes a plurality of recessed portions 47, similarly to the second member 44B. The measuring probe 52C is put in and held in the recessed portion 47 of the first member 44A and the second member 44B. With such a configuration, the photo-detection unit 50 can irradiate the portion 21C that captures the target substance of the metal-film coated photonic crystal 21 with light through the closely adjacent opening portions 23P1, 23P2, and 23P3, and can receive the reflected light.

As explained above, the present embodiment can introduce the liquid to each of the opening portions 23P1, 23P2, and 23P3 included in the photonic crystal biosensor 11C. Therefore, the metal-film coated photonic crystal 21 can be calibrated at the same time of an inspection. As a result, the present embodiment can realize highly accurate measurement. Further, the volume of a space surrounded by the opening portions 23P1, 23P2, and 23P3, the supporting member 24C, and the covering member 22 is small. Therefore, the amount of the liquid to be supplied to the opening portions 23P1, 23P2, and 23P3 can be small.

### Third Embodiment

### Target Substance Detecting Device

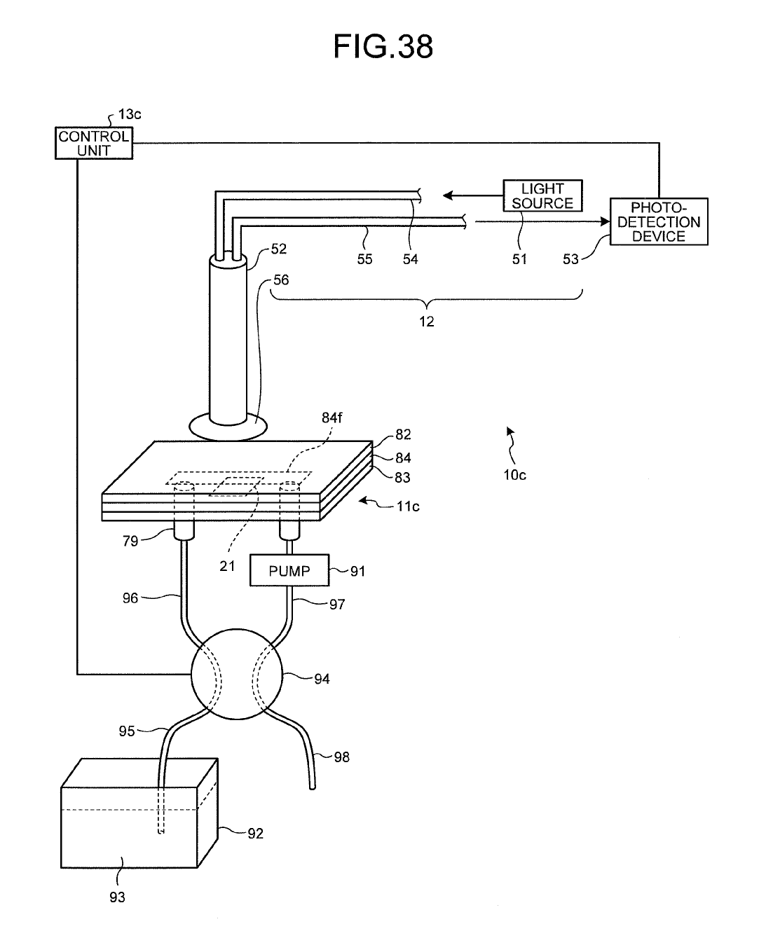

FIG. 38 is a diagram illustrating a target substance detecting device. A target substance detecting device including a target substance capturing device according to a third embodiment will be explained. A target substance detecting device 10c includes a photonic crystal biosensor (target substance capturing device) 11c according to the third embodiment, a photo-detection section 12, and a control unit 13c.

(Photonic Crystal Biosensor)

First, a photonic crystal biosensor 11c will be explained. The photonic crystal biosensor 11c includes a metal-film coated photonic crystal 21, a table 83, a thin plate 84, and a cover 82. In the third embodiment, the photonic crystal biosensor 11c has a structure in which the metal-film coated photonic crystal 21 is arranged in a flow path 84f formed by the table 83, the thin plate 84, and the cover 82. The metal-film coated photonic crystal 21 is similar to that in the first embodiment, and thus description is omitted.

(Method of Manufacturing Photonic Crystal Biosensor)

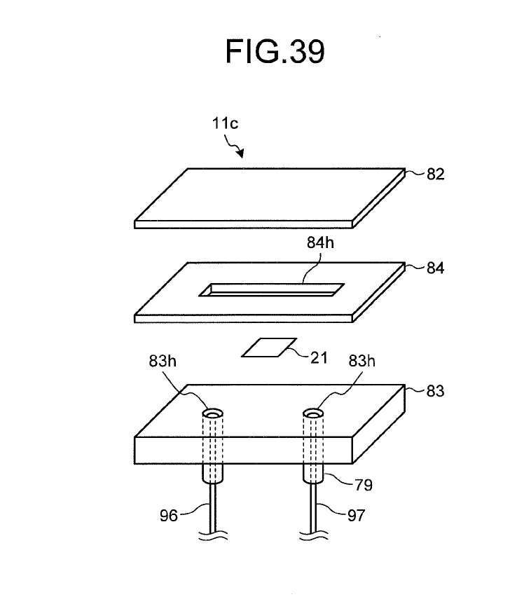

Next, an example of manufacturing of the photonic crystal biosensor 11c illustrated in FIG. 38 will be explained. FIG. 39 is an explanatory diagram of the photonic crystal biosensor 11c. The photonic crystal biosensor 11c includes the metal-film coated photonic crystal 21, the table 83 having two through holes 83h, the thin plate 84 having an opening portion 84h, and the cover 82. The metal-film coated photonic crystal 21 is placed on a surface of the table 83. Following that, the thin plate 84 is placed on the table 83. For example, in the third embodiment, the width of the metal-film coated photonic crystal 21 is smaller than the width of the opening portion 84h. Therefore, the metal-film coated photonic crystal 21 is sandwiched and fixed by the table 83 and the thin plate 84. The cover 82 is placed on the thin plate 84. With the above-described configuration, the photonic crystal biosensor 11c has the flow path 84f formed by being surrounded by the table 83, inner walls of the thin plate 84 facing the opening portion 84h, and the cover 82. The inner walls facing the opening portion 84h refer to inner walls of the thin plate 84, which are boundary surfaces between the thin plate 84 and the opening portion 84h. Accordingly, the metal-film coated photonic crystal 21 is arranged in the flow path 84f. A solution that contains a target substance flows inside the flow path 84f, so that a reflection surface 69 captures the target substance. Note that the flow path 84f may not be formed as explained above. For example, the flow path 84f may be formed such that a part of the surface of the table 83 is depressed.

The photonic crystal biosensor 11c includes a supply pipe 96 and a discharge pipe 97. The solution is supplied through the supply pipe 96 to the flow path 84f. The solution is discharged through the discharge pipe 97 from the flow path 84f.

Materials of the table 83 and the cover 82 are not especially limited. However, it is preferable to use stainless steel, a poly cycloolefin-based polymer resin, or silica, in light of cleanliness of the cover 82 and the surface of the table 83.

One of the two through holes 83h is a supply port that allows the solution to flow into the flow path 84f. The other of the two through holes 83h is a discharge port that allows the solution to be discharged from the flow path 84f. A supply pipe 96 including a connector 79 on a tip is connected with one of the two through holes 83h. A discharge pipe 97 including a connector 79 on a tip is connected with the other of the two through holes 83h. The solution flows in the flow path 84f through the supply pipe 96, and flows out from the flow path 84f through the discharge pipe 97. Further, the connectors 79 block the two through holes 83h. Therefore, the connectors 79 decrease a possibility that the solution leaks from the flow path 84f. Note that the through holes 83h, the supply pipe 96, and the discharge pipe 97 may not be provided. Even when the through holes 83h, the supply pipe 96, and the discharge pipe 97 are not provided, the solution circulates in the flow path 84f as long as the flow path 84f is formed in an annular manner. Further, three or more through holes 83h may be provided.

The photonic crystal biosensor 11c is uniformly manufactured by heat nanoimprint or the like. To cause the target substance detecting device 10c to be able to more accurately detect the reflected light, it is preferable to accurately position an incident part and a reflection part of the light irradiating the photonic crystal biosensor 11c.

That is, it is preferable that a positional relationship between the photonic crystal biosensor 11c and a measuring probe explained below at the time of measurement is the same before and after an antigen/antibody reaction, and that the same portion is measured. Therefore, it is preferable that a distance between the measuring probe and a reflection surface 69 of the photonic crystal biosensor 11c is the same before and after the antigen/antibody reaction, and it is preferable to fix the distance from 50 μm to 500 μm. The photonic crystal biosensor 11c includes the cover 82, so that the cover 82 functions as a spacer, and can keep the distance between the measuring probe and the reflection surface 69 of the photonic crystal biosensor 11c constant.

Further, the photonic crystal biosensor 11c may be marked with a positioning marker that displays a specific position on the reflection surface 69. The marker may be provided by photolithography, sputtering, deposition, or a liftoff process using the aforementioned methods, printing with an ink, pattern formation by imprint, or the like. The marker may be attached to either a surface (the reflection surface 69 side) or a back surface (an opposite side to the reflection surface 69) of the photonic crystal biosensor 11c as long as the position of the marker can be read. Further, the marker may be attached to a photonic crystal 65 itself, except a measuring portion of the photonic crystal 65. Further, the marker may be attached to the cover 82 or the table 83.

(Method of Circulating Solution)

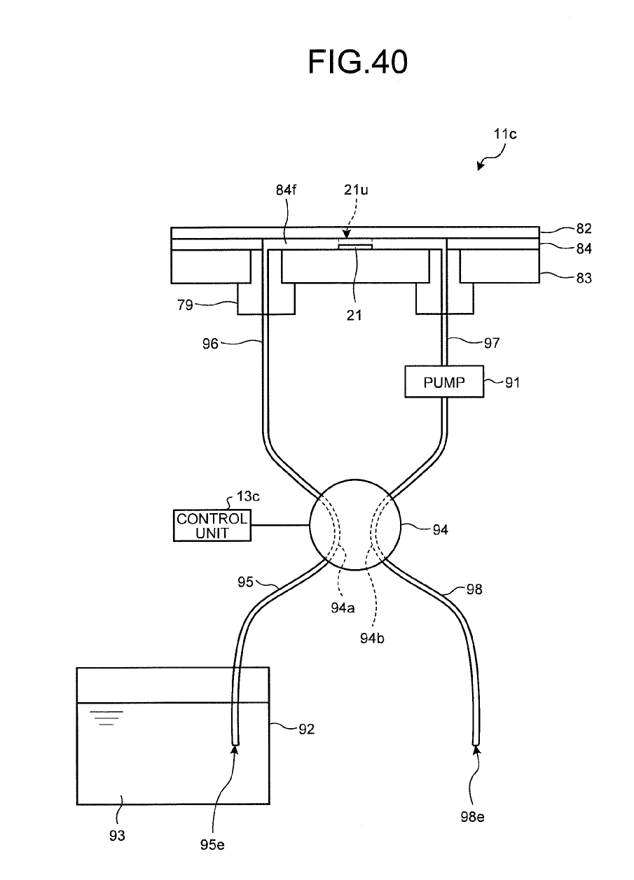

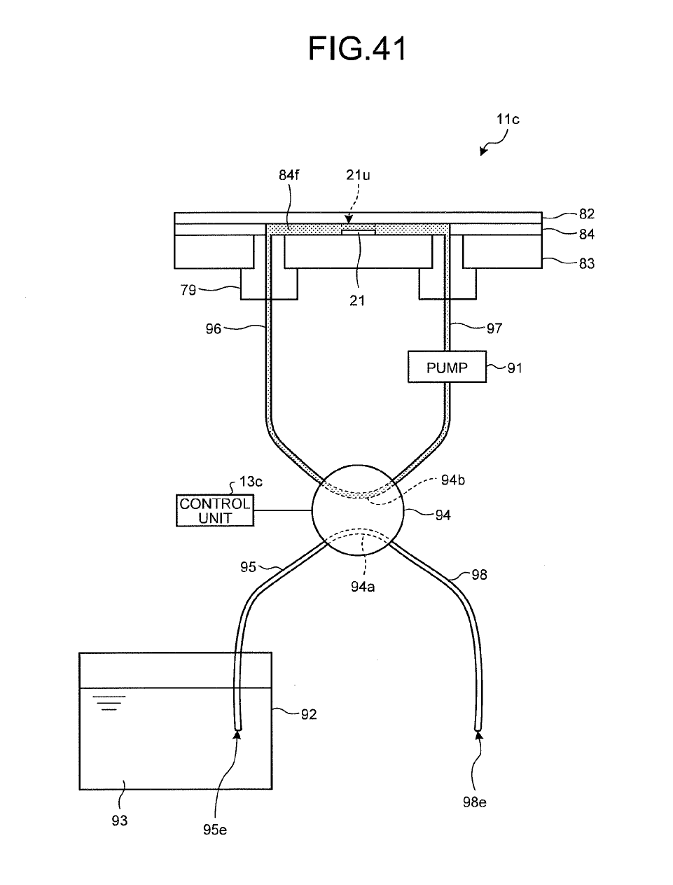

FIG. 40 is a diagram illustrating a state before the solution is supplied to the flow path 84f. FIG. 41 is a diagram illustrating a state in which the solution is circulated. The photonic crystal biosensor 11c includes a pump 91, a valve 94, a supply pipe 95, a discharge pipe 98, a container 92, and a new solution 93. As illustrated in FIG. 40, the supply pipe 96 is connected with the supply pipe 95 through a passage 94a in the valve 94. An end portion 95e of the supply pipe 95 is immersed in the new solution 93 stored in the container 92. The discharge pipe 97 is connected with the discharge pipe 98 through a passage 94b in the valve 94. The control unit 13c is connected with the valve 94, and can switch a direction to introduce the solution. Further, in the third embodiment, the pump 91 is provided in the discharge pipe 97. The pump 91 exhibits a function to apply negative pressure to the flow path 84f. Note that the pump 91 may be provided in the supply pipe 96. When the pump 91 is provided in the supply pipe 96, the pump 91 exhibits a function to apply positive pressure to the flow path 84f.

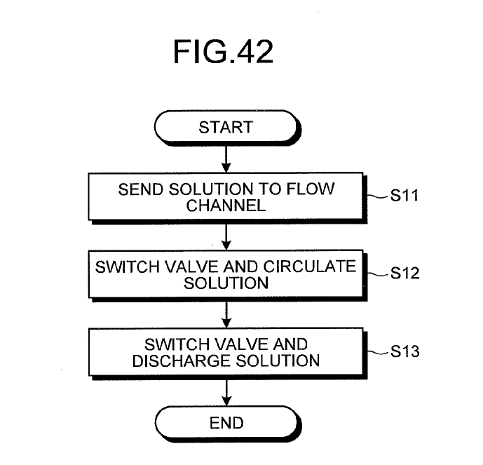

FIG. 42 is a flowchart illustrating an example of a method of circulating a solution according to the third embodiment. Hereinafter, a method of circulating a solution will be explained. First, in step S11, the pump 91 sends the solution stored in the container 92 to the flow path 84f. When the pump 91 is operated, the negative pressure is applied to the flow path 84f. Therefore, the pressure is transferred to the supply pipes 95 and 96 connected with the flow path 84f, and the new solution 93 stored in the container 92 is sucked from the end portion 95e of the supply pipe 95. As a result, the solution flows into the flow path 84f. Following that the solution passes through a space 21u above the reflection surface 69, and reaches the passage 94b through the discharge pipe 97.

Next, in step S12, the valve 94 is switched and the solution is circulated. When the passage 94b is filled with the solution, the control unit 13c switches the valve 94. Accordingly, as illustrated in FIG. 41, the supply pipe 96 and the discharge pipe 97 are connected through the passage 94b. The solution passes through the supply pipe 96, the flow path 84f, and the discharge pipe 97, and is circulated. The solution that has passed through the flow path 84f is repeatedly introduced to the flow path 84f. Accordingly, the solution that has passed through the space 21u above the reflection surface 69 is repeatedly introduced to the space 21u above the reflection surface 69. When the solution passes through the space 21u above the reflection surface 69, a part of the target substance contained in the solution is captured on the reflection surface 69. However, a target substance that passes through the space 21u above the reflection surface 69 without being captured on the reflection surface 69 exists. By circulating the solution, the reflection surface 69 can repeatedly obtain an opportunity to capture the target substance that has passed through the space 21u above the reflection surface 69 without being captured.

Next, in step S13, the end portion 95e of the supply pipe 95 is pulled up from the new solution 93 stored in the container 92, after termination of measurement of reflected light, and the valve 94 is switched. When the valve 94 is switched, the discharge pipe 97 is connected with the discharge pipe 98 through the passage 94b. Accordingly, the solution inside the flow path 84f, the supply pipe 96, and the discharge pipe 97 is discharged from an end portion 98e of the discharge pipe 98. Further, a method of circulating the solution may not be the above-described method.

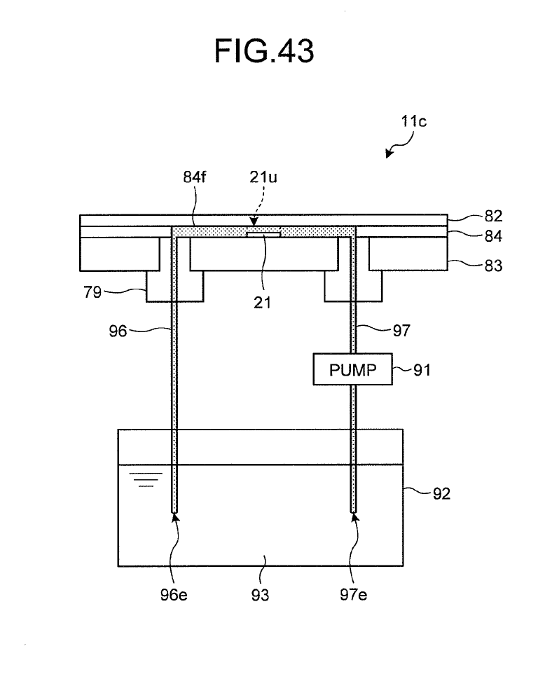

FIG. 43 is an explanatory diagram of another circulation method. For example, the method of circulating a solution may be a method using a configuration illustrated in FIG. 43. As illustrated in FIG. 43, an end portion 96e of the supply pipe 96 and an end portion 97e of the discharge pipe 97 are immersed in the new solution 93 stored in the container 92. Under this state, when the pump 91 is operated, the negative pressure is applied to the flow path 84f. Therefore, the pressure is transferred to the supply pipe 96 connected with the flow path 84f, and the new solution 93 stored in the container 92 is sucked from the end portion 96e of the supply pipe 96. As a result, the solution flows into the flow path 84f. Following that, the solution is discharged from the end portion 97e of the discharge pipe 97, and flows into the container 92. Note that the pump 91 may be provided in the supply pipe 96. In this case, the pump 91 exhibits a function to apply the positive pressure to the flow path 84f.

In the photonic crystal biosensor 11c according to the third embodiment, the solution that has passed through the space 21u above the reflection surface 69 is repeatedly introduced to the space 21u above the reflection surface 69. Accordingly, the solution that has passed through the space 21u above the reflection surface 69 without having a reaction with the metal-film coated photonic crystal 21 can repeatedly have an opportunity to react with the metal-film coated photonic crystal 21. Therefore, even if a flow speed of the solution is made large, the amount of the solution necessary to reach an equilibrium state is not increased. Therefore, the photonic crystal biosensor 11c according to the third embodiment can decrease the amount necessary to reach the equilibrium state, while making change of the reflected light of the light irradiating the metal-film coated photonic crystal 21 fast.

Further, in the photonic crystal biosensor 11c according to the third embodiment, the solution is supplied through the supply pipe 96 to the flow path 84f. The solution is discharged from the flow path 84f through the discharge pipe 97. Accordingly, the pump 91 for moving the solution can be installed outside the flow path 84f. Since the flow path 84f is very small, when the pump 91 can be installed outside the flow path 84f, assembly of the photonic crystal biosensor 11c becomes easy. Therefore, the photonic crystal biosensor 11c according to the third embodiment can be easily assembled, and can decrease the amount of the solution necessary to reach the equilibrium state, while making the change of the reflected light of the light irradiating the metal-film coated photonic crystal 21 faster.

Further, the photonic crystal biosensor 11c according to the third embodiment includes the flow path 84f formed by being surrounded by the table 83, the inner walls of the thin plate 84 facing opening portion 84h, and the cover 82. Accordingly, the flow path 84f can be formed to be thin, and thus the flow speed of the solution that passes through the space 21u above the reflection surface 69 can be made large. Accordingly, the target substance can be promptly captured on the reflection surface 69. Therefore, the photonic crystal biosensor 11c according to the third embodiment can decrease the amount of the solution necessary to reach the equilibrium state, while making the change of the reflected light of the light irradiating the metal-film coated photonic crystal 21 faster.

Next, an experiment result using the target substance detecting device illustrated in FIG. 38 will be explained. An example is a result of an experiment in which real-time measurement of the reflected light was performed using the above-described circulation method. The example is a result of an experiment in which the solution was circulated in the flow path 84f such that the flowing amount per unit time becomes 300 μl/min, and the Reynolds number becomes 4.0. In the example, the amount of the solution used to flow in the flow path 84f was 1.5 ml. Further, the example is a result of an experiment in which real-time measurement of the reflected light was performed, in a state where the solution did not flow and stood still. In both of the example and a comparative example, biotin was fixed to the reflection surface 69, and avidin of 100 nM was brought to have a react.

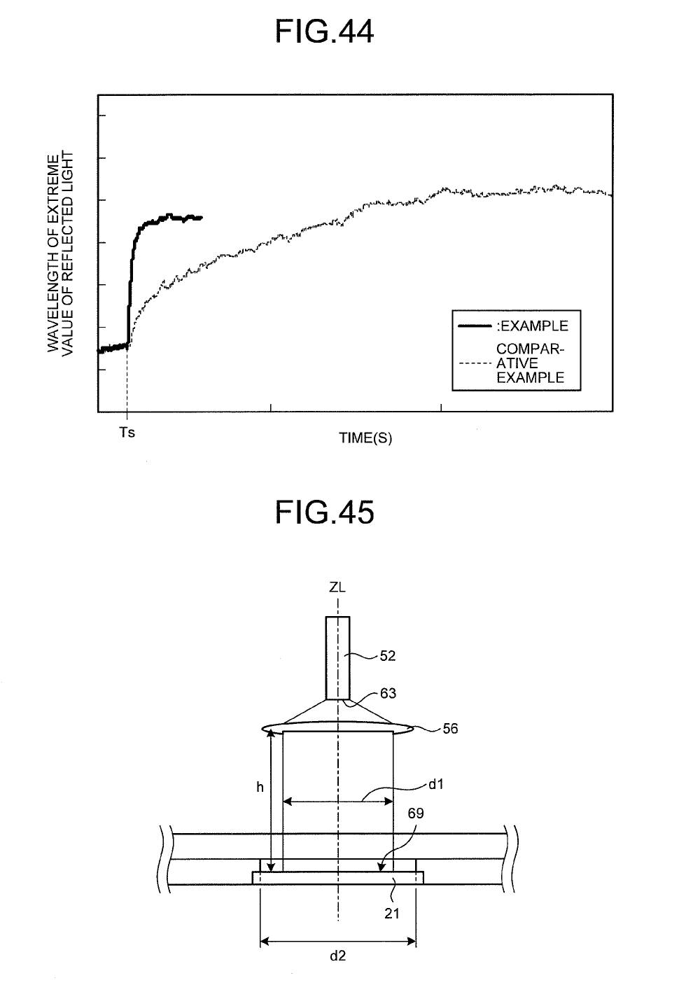

FIG. 44 is a diagram illustrating change of a wavelength of an extreme value of reflected light with respect to time, in the example and the comparative example. The solution starts being in contact with the reflection surface 69 from a time Ts. Comparing the example and the comparative example, it has been found that the example more promptly reacts. Therefore, the photonic crystal biosensor 11c according to the third embodiment can decrease the amount of the solution necessary to reach the equilibrium state, while making the change of the reflected light of the light irradiating the metal-film coated photonic crystal 21 fast.

Further, a relationship between the flow speed of the solution and a cross section shape of the flow path 84f is preferably a relationship where the Reynolds number becomes from 0.01 to 2000, both inclusive. When the Reynolds number is 2000 or less, a turbulent flow component is less likely to occur, and thus a possibility of occurrence of a noise in the measurement result of the reflected light becomes low. Further, when the Reynolds number is 2000 or less, large pressure is less likely to be applied to the flow path 84f, and thus a possibility of leakage of the solution from the flow path 84f becomes low. Further, the relationship between the flow speed of the solution and the cross section shape of the flow path 84f is preferably a relationship where the Reynolds number becomes from 0.01 to 1000, both inclusive. When the Reynolds number is 1000 or less, a stable laminar flow is more likely to occur, and thus a possibility of occurrence of a noise in the measurement result of the reflected light becomes lower.

FIG. 45 is a diagram illustrating an evaluation condition of the photo-detection section 12 of the target substance detecting device 10c according to the third embodiment. Next, an evaluation condition of the photo-detection section 12 will be explained. As illustrated in FIG. 45, in the photo-detection section 12, a collimating lens 56 is arranged between an incident/emission surface 63 of a measuring probe 52 and the reflection surface 69 of the metal-film coated photonic crystal 21. A distance (measurement distance) between the collimating lens 56 and the reflection surface 69 is h, and a diameter of parallel light emitted through the collimating lens 56 on the reflection surface 69 is d1, and a diameter of a position where the reflection surface 69 of the photonic crystal 65 is exposed is d2. In the present evaluation, h was 15 mm or 40 mm, d1 was 3.5 mm, and d2 was 5 mm. Both of an optical axis ZL of the light irradiating the reflection surface 69 and an optical axis ZL of the reflected light reflected at the reflection surface 69 are perpendicular to the reflection surface 69. A diameter of the measuring probe 52 is 200 μm. The light irradiating the reflection surface 69 was white light. Reflectance is a ratio of a standard substance (aluminum plate) to reflected light intensity.

(Control Unit 13c)

Next, the control unit 13c illustrated in FIG. 38 will be explained. The control unit 13c obtains a wavelength of an extreme value of the reflected light detected by the photo-detection section 12. The control unit 13c detects existence/non-existence of at least the target substance (antigen 76 illustrated in FIGS. 11 and 12, for example), based on shifting (a wavelength shift amount) of the obtained wavelength of an extreme value. The control unit 13c is, for example, a microcomputer. The wavelength shift amount and the concentration of the target substance captured on the reflection surface 69 of the metal-film coated photonic crystal 21 has a correlation. Therefore, the control unit 13c can obtain the concentration of the target substance captured on the reflection surface 69 from the wavelength shift amount. Further, the control unit 13c is connected with the valve 94. The control unit 13c switches the valve 94, based on a state of the passage 94b in the valve 94.

(Method of Detecting Target Substance)

Next, a method of detecting the target substance (target substance detection method) using a target substance detecting device 10 illustrated in FIG. 1 and the target substance detecting device 10c illustrated in FIG. 38 will be explained. In this example, a case in which a cortisol antibody is absorbed on the reflection surface 69 of the metal-film coated photonic crystal 21, and cortisol in saliva is detected and measured as the target substance to be detected will be explained. As the photonic crystal 65, one obtained such that a cycloolefin-based polymer sheet having a predetermined microstructure formed on a surface by heat nanoimprint is cut into a predetermined size is used.

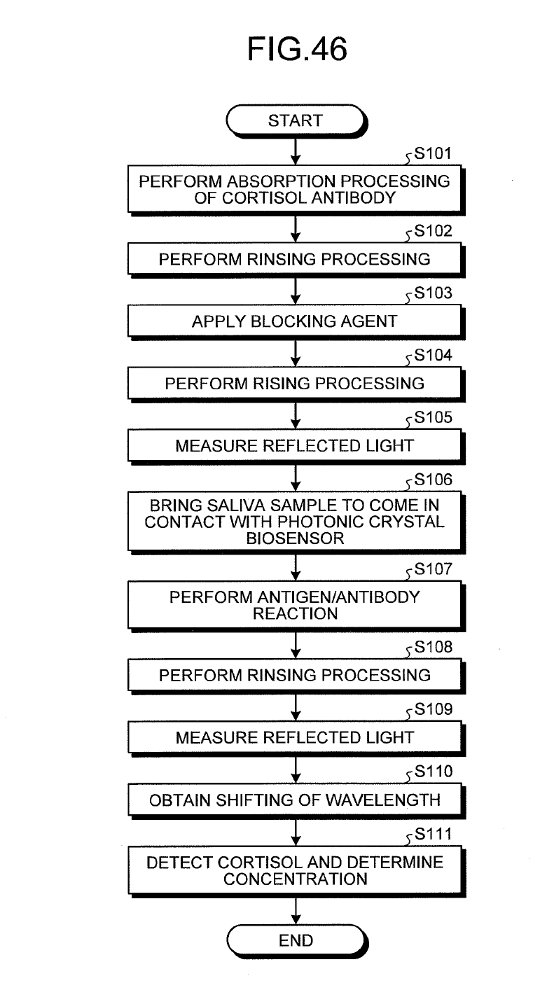

FIG. 46 is a flowchart illustrating an example of a method of detecting a target substance according to the third embodiment. First, in step S101, a cortisol antibody solution (the cortisol antibody concentration is from 1 μg/ml to 1000 μg/ml) is brought to come in contact with the reflection surface 69 of the metal-film coated photonic crystal 21. Then, the reflection surface 69 of the metal-film coated photonic crystal 21 is exposed to the cortisol antibody solution for a predetermined time, or at a predetermined temperature for a predetermined time, as needed. In this way, the cortisol antibody is absorbed on the reflection surface 69 of the metal-film coated photonic crystal 21.

Next, in step S102, phosphate buffered saline (PBS) is brought to come in contact with the reflection surface 69 of the metal-film coated photonic crystal 21. Following that, rinsing processing that performs removal using centrifugal force or the like is performed several times.

Next, in step S103, skim milk, as a blocking agent 75, is brought to come in contact with the reflection surface 69 of the metal-film coated photonic crystal 21. The reflection surface 69 of the metal-film coated photonic crystal 21 is exposed to the skim milk for a predetermined time, or at a predetermined temperature for a predetermined time, as needed. In this way, the skim milk is absorbed in a non-absorption portion of the cortisol antibody on the reflection surface 69 of the metal-film coated photonic crystal 21.

Following that, in step S104, rinsing processing with the phosphate buffered saline is performed several times, similarly to the rinsing processing (step S102). With the above operation, predetermined processing is applied on the reflection surface 69 of the metal-film coated photonic crystal 21, and the photonic crystal biosensor 11c is formed.

Next, in step S105, the photo-detection section 12 detects reflected light LR from the reflection surface 69 when the reflection surface 69 of the photonic crystal 65 is irradiated with light, and the control unit 13c measures the reflected light LR. The control unit 13c measures a spectrum of reflected light intensity of the reflected light LR. The wavelength of the light (incident light LI) irradiating the reflection surface 69 is, for example, from 300 nm to 2000 nm, both inclusive.

Next, in step S106, first, saliva as a solution containing cortisol is prepared. Sampling of the saliva and pretreatment such as removal of impurities are performed using a commercially available saliva collecting kit. The preparation of the saliva can be performed at any time before the saliva is brought to come in contact with the photonic crystal biosensor 11c. For example, the preparation of the saliva may be performed before the formation of the photonic crystal biosensor 11c, may be performed in parallel with the formation of the photonic crystal biosensor 11c, or may be performed after the measurement of the reflected light intensity. 10 μL to 50 μL of the saliva subjected to the sampling and the pretreatment is brought to come in contact with the photonic crystal biosensor 11c.

Next, in step S107, the reflection surface 69 of the metal-film coated photonic crystal 21 is exposed to the solution containing cortisol, for a predetermined time, or at a predetermined temperature for a predetermine time, as needed. In this way, the antigen/antibody reaction is performed. The antigen/antibody reaction of step 107 is performed while the solution is circulated in step S2 of FIG. 42.

Following that, in step S108, rinsing processing is performed with the phosphate buffered saline several times, similarly to the rinsing processing (step S104).

Next, in step S109, the reflection surface 69 of the metal-film coated photonic crystal 21 is irradiated with light, using the target substance detecting device 10c. The light irradiating the reflection surface 69 at this time is the same as the light irradiating the reflection surface 69 in step S15. Then, the target substance detecting device 10c measures the spectrum of the reflected light intensity of the reflected light LR from the reflection surface 69.

The wavelength in the extreme value of the reflected light intensity of the photonic crystal biosensor 11c is changed, by being subject to the antigen/antibody reaction on the reflection surface 69 or in the vicinity of the reflection surface 69. Therefore, cortisol in the saliva can be detected from a difference between the wavelengths in the extreme value of the reflected light intensity before and after the reaction, that is, the wavelength shift amount. Further, the concentration of cortisol in the saliva can be obtained from the wavelength shift amount.

In step S110, the control unit 13c obtains shifting (wavelength shift amount) of the wavelength in the extreme value (minimum value) of the reflected light intensity (or the reflectance) measured in step S109. The wavelength shift amount is, for example, a difference λ2−λ1 between the wavelength λ2 after the target substance is captured on the reflection surface 69, and the wavelength λ1 corresponding to the extreme value (minimum value) of the reflected light intensity (or the reflectance) of when the target substance is not captured on the reflection surface 69.

In step S111, the control unit 13c determines that cortisol exists in the saliva, when there is a predetermined amount or more of the wavelength shift amount. Further, the control unit 13c determines the concentration of cortisol, using a relational expression between the wavelength shift amount and the concentration of cortisol, based on the wavelength shift amount. At this time, the relational expression is obtained in advance, and is stored in a storage unit of the control unit 13c.

In the above-described example, the wavelength shift amount is obtained using the wavelength of the extreme value of the reflected light intensity on the reflection surface 69 in a state where the target substance is not captured. However, an embodiment is not limited to the example. Further, in steps S15 and S19, when there is a plurality of extreme values, an extreme value to be focused is appropriately selected. Then, the wavelength λ1 and the wavelength λ2 are obtained about the selected extreme value.

Note that, in the third embodiment, in the metal-film coated photonic crystal 21, the antibody 74 is fixed to the reflection surface 69. However, an embodiment is not limited to the example, and the metal-film coated photonic crystal 21 may be used where the antibody 74 is not fixed to the reflection surface 69.

### Fourth Embodiment

A target substance detecting device including a target substance capturing device according to a fourth embodiment will be explained. A target substance capturing device according to the fourth embodiment is similar to the third embodiment, except that a substance to be fixed to a reflection surface 69 of a metal-film coated photonic crystal 21 is an antigen (target substance) 76, and an antibody 74 is absorbed by the antigen 76, and thus overlapping description is omitted.

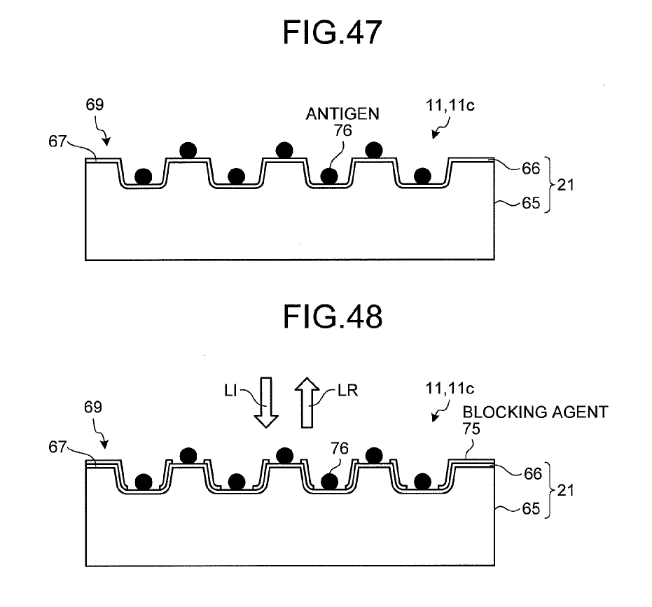

FIGS. 47 to 51 are diagrams for explaining a principle of a photonic crystal biosensor. In the fourth embodiment, as a special reaction between the antibody 74 and the antigen 76, description will be given using cortisol as the antigen 76, and an anti-cortisol antibody as the antibody 74.

First, as illustrated in FIG. 47, the photonic crystal biosensor 11c can similarly perform means for fixing the antibody 74 to the reflection surface 69, as means for fixing the antigen 76 to the reflection surface 69 of the metal-film coated photonic crystal 21. Examples of the means for fixing the antigen 76 to the reflection surface 69 include chemical bond and physical bond methods such as covalent bond, chemisorption, and physisorption. These means can be appropriately selected according to the nature of the antigen 76.

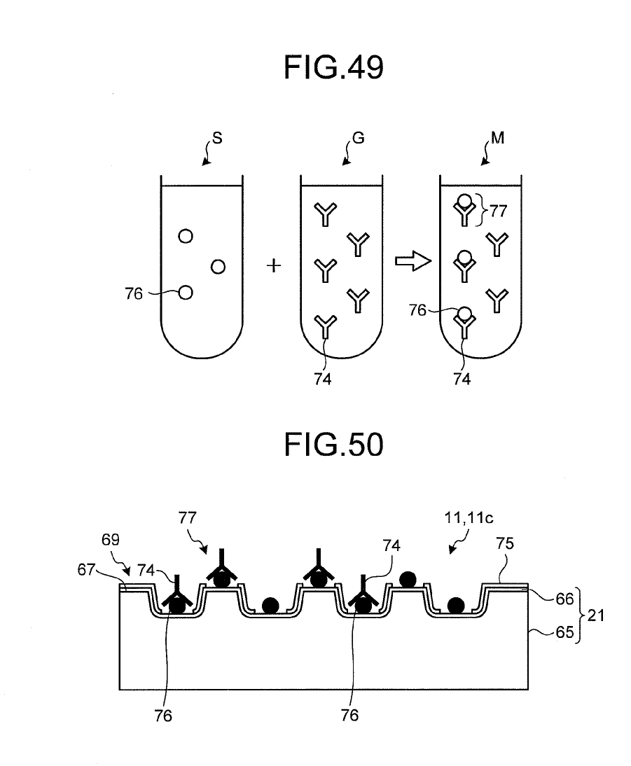

The amount of the antigen 76 fixed to the metal-film coated photonic crystal 21 is constant. Therefore, when the antibody 74 is absorbed to the antigen 76 fixed to the metal-film coated photonic crystal 21 and a complex 77 (see FIGS. 49 and 50) is formed, the photonic crystal biosensor 11c can output a physical amount that correlates with the amount of the formed complex 77. The constant amount of the fixed antigen 76 may be appropriately changed, and can be set to an optimum amount according to a range of the amount of the antigen 76 contained in a sample S, for example.

Following that, as illustrated in FIG. 48, the blocking agent 75 is fixed to a place of the reflection surface 69, where the antigen 76 is not attached.

Next, the reflection surface 69 of the photonic crystal 65 is irradiated with the light (incident light) LI of from 300 nm to 900 nm, both inclusive, in parallel light, and such that the optical axis is perpendicular to the reflection surface 69. A wavelength with which the intensity or the reflectance of the reflected light LR of this time becomes the extreme value (the minimum value in this example) is λ1.

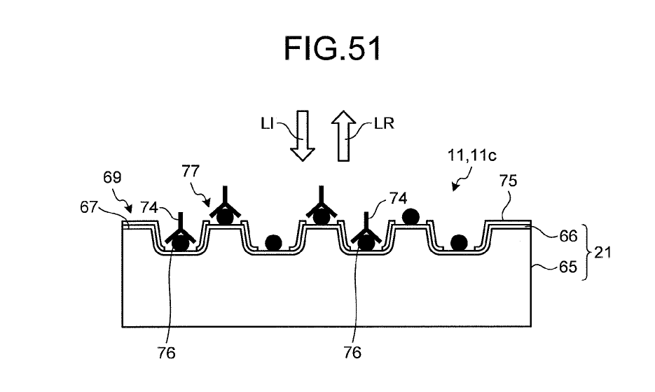

Next, as illustrated in FIG. 49, a mixture M that contains the complex 77 of the antigen 76 and the antibody 74, and the antibody 74 is prepared. The mixture M can be obtained by mixing a sample S that contains the antigen 76 and a solution G that contains a known amount of the antibody 74. The complex 77 can be obtained such that the sample S that contains the antigen 76, and the solution G that contains a known amount of the antibody 74 are mixed, and the antibody 74 and the antigen 76 react with each other. In mixing, the concentration of the solution G is adjusted in advance such that the total amount of a combining site with the antigen 76 included in the antibody 74 contained in the solution G becomes larger than the total amount of the antigen 76 contained in the sample S. Accordingly, the combining site of a part of the antibody 74 contained in the mixture M is not combined with the antigen 76, and the part of the antibody 74 remains. The mixture M is brought to come in contact with the reflection surface 69 of the metal-film coated photonic crystal 21. Accordingly, as illustrated in FIG. 50, the complex 77 is formed on the reflection surface 69 by the antigen 76 fixed to the reflection surface 69 and the antibody 74. Following that, as illustrated in FIG. 51, the reflection surface 69 of the metal-film coated photonic crystal 21 is irradiated with the light (incident light) LI of from 300 nm to 2000 nm, both inclusive, in parallel light, and such that the optical axis is perpendicular to the reflection surface 69. A wavelength with which the reflected light intensity or the reflectance of the reflected light LR of this time becomes the extreme value (the minimum value in this example) is λ2.

The wavelength shift amount of the wavelength with which the reflectance of light becomes the extreme value is λ2−λ1. The wavelength shift amount is changed according to change of a surface state on the reflection surface 69 of the metal-film coated photonic crystal 21. Detection and quantification of the antigen 76 are performed based on the wavelength shift amount. The photonic crystal biosensor 11c outputs an optical physical amount. This physical amount correlates with the change of the surface state on the reflection surface 69, and correlates with the amount of the complex 77 formed by the antigen 76 and the antibody 74 fixed to the reflection surface 69.

In the fourth embodiment, cortisol as the antigen 76 is fixed to the metal-film coated photonic crystal 21, and the anti-cortisol as the antibody 74 is brought to react with cortisol. The change of the surface state of the metal-film coated photonic crystal 21 becomes large, and the sensitivity of the photonic crystal biosensor 11c is improved, in the case such as the fourth embodiment in which the anti-cortisol antibody is brought to react with cortisol after cortisol is fixed to the reflection surface 69 of the metal-film coated photonic crystal 21, compared with the case such as the third embodiment in which the antigen 76 is brought to react with the antibody 74 after the antibody 74 is fixed to the reflection surface 69 of the metal-film coated photonic crystal 21.

Next, a method of measuring the concentration of the antigen 76 will be explained. An amount of a combining site of the antigen 76 contained in the sample S is X, and the known amount of the antibody 74 in the mixture M is C. With regard to the relationship between X and C, X is made smaller than C (X<C). In the mixture M, the antigen 76 and the antibody 74 have an antigen/antibody reaction, and the complex 77 is formed. Since X is smaller than C (X<C), the amount of the antibody 74 in the mixture M becomes C−X. Then, the mixture M is brought to come in contact with the reflection surface 69 to which the constant amount of the antigen 76 is fixed, the antibody 74 in the mixture M have the antigen/antibody reaction with the antigen 76 of the reflection surface 69, and the complex 77 is formed. The amount of the antigen 76 fixed to the reflection surface 69 is equal to or more than the amount C−X of the antibody 74 in the mixture M.

When all of the antibodies 74 in the mixture M have the antigen/antibody reaction with the antigen 76 of the reflection surface 69, the amount of the complex 77 becomes C−X. A wavelength shift amount Δλ obtained from the wavelengths λ1 and λ2 measured before and after the mixture M is brought to come in contact with the reflection surface 69 corresponds to the amount of the complex 77 fixed to the reflection surface 69. Therefore, Δλ=k×(C−X) is satisfied. k is a constant for converting the wavelength shift amount Δλ into the amount of the complex 77. The relationship between the amount of the complex 77 fixed to the reflection surface 69 and the wavelength shift amount Δλ is obtained in advance. From the above relational expression, the amount X of the antigen 76 can be obtained by C−Δλ/k. The concentration of the antigen 76 can be obtained based on the amount X of the antigen 76.

Further, in the fourth embodiment, the photonic crystal biosensor 11c may cause a secondary antibody which specially reacts with the complex 77, to react with the complex 77 fixed to the reflection surface 69 of the metal-film coated photonic crystal 21. The secondary antibody functions as a complex binding substance. An excessive amount of the secondary antibody than that of the first complex (complex) 77 is brought to come in contact with the reflection surface 69 of the metal-film coated photonic crystal 21. Then, the secondary antibody is attached to all of the complexes 77 to obtain a second complex. Accordingly, the change of the surface state of the metal-film coated photonic crystal 21 becomes larger. As a result, the sensitivity of the photonic crystal biosensor 11c is further increased. The secondary antibody can be used as it is, or may be used by adding another substance. The change of the surface state of the metal-film coated photonic crystal 21 becomes larger as the secondary antibody is larger. Therefore, after another substance is added to the secondary antibody, the secondary antibody is brought to react with the complex 77, so that the sensitivity of the photonic crystal biosensor 11c is further increased.

When the second complex is formed on the reflection surface 69, the reflection surface 69 of after the second complex is formed is irradiated with light. A wavelength with which the reflected light intensity or the reflectance obtained as a result becomes the extreme value (the minimum value in this example) is λ2. When there is a plurality of extreme values, an extreme value to be focused is appropriately selected. The wavelength λ1 and the wavelength λ2 are obtained about the selected arbitrary extreme value. The photonic crystal biosensor 11c outputs an optical physical amount. This physical amount correlates with the change of the surface state on the reflection surface 69, and correlates with the amount of the second complex fixed to the reflection surface 69. Then, the second complex is detected and quantified. The amount of the second complex is the same as the amount of the complex 77. Therefore, the complex 77 can be quantified.

Configuration elements of the above-described first to third embodiments include those that can be easily assumed by persons skilled in the art, those that are substantially identical, and those in a scope of so-called equivalents. Further, the above-described configuration elements can be appropriately combined. Further, various omissions, replacements, and changes of the configuration elements can be performed without departing from the gist of the present embodiments.

### REFERENCE SIGNS LIST

10 Target substance detecting device
11 Photonic crystal biosensor (target substance capturing device)
12 Photo-detection section
13 Processing unit
13c Control unit
LI Incident light
LR Reflected light

1. A target substance capturing device comprising:
a supporting member to place and support a metal-film coated structure that captures a target substance, the supporting member including at least two holes opening at portions different from a portion where the metal-film coated structure is placed;
a holding member to put the metal-film coated structure in between the holding member and the supporting member, the holding member including an opening portion that overlaps with the holes of the supporting member, and a portion that captures the target substance of the metal-film coated structure placed on the supporting member; and
a covering member having transparency and covering the opening portion of the holding member.

2. The target substance capturing device according to claim 1, wherein the holes are two of a supply hole and an discharge hole, the supply hole supplying a liquid containing the target substance to a space surrounded by the covering member, an inner surface of the opening portion, and the supporting member, and the discharge hole discharging the liquid from the space.

3. The target substance capturing device according to claim 1, wherein a portion of the holding member, the portion being in contact with the metal-film coated structure, is formed of at least silicone.

4. The target substance capturing device according to claim 3, wherein the portion of the holding member, the portion being in contact with the metal-film coated structure, is formed of at least polydimethylsiloxane.

5. The target substance capturing device according to claim 1, wherein the supporting member is formed of a fluororesin.

6. The target substance capturing device according to claim 1, wherein the supporting member has transparency.

7. The target substance capturing device according to claim 1, wherein the supporting member includes a plurality of claws to engage with the holding member that puts the metal-film coated structure in between the holding member and the supporting member, at a side where the metal-film coated structure is placed.

8. The target substance capturing device according to claim 1, wherein the covering member is fitted into the opening portion of the holding member.

9. A target substance detecting device comprising:
the target substance capturing device according to claim 1;
a photo-detection section irradiating a portion that captures the target substance with parallel light from the opening portion, and detecting reflected light of the parallel light reflected at the portion that captures the target substance; and
a processing unit configured to obtain a wavelength of an extreme value of the reflected light detected by the photo-detection section, and to detect existence/non-existence of at least the target substance, based on shifting of the obtained wavelength of an extreme value.

10. The target substance detecting device according to claim 9, comprising:
a liquid sending device supplying the liquid to the space through the hole, and to discharge the liquid from the space through the hole.

11. The target substance detecting device according to claim 9, wherein
the photo-detection section includes a first spectrometer and a second spectrometer having higher resolution of a wavelength of detectable light than the first spectrometer, and
the processing unit obtains the wavelength of an extreme value of the reflected light, using the first spectrometer, and then obtains the wavelength of an extreme value of the reflected light, within a range of the wavelength of an extreme value obtained by the first spectrometer, using the second spectrometer.

12. The target substance detecting device according to claim 11, wherein
the wavelength of an extreme value of the reflected light is obtained, by performing fitting of at least one of a detection result of the first spectrometer and a detection result of the second spectrometer, with a function.

13. The target substance detecting device according to claim 9, comprising:
a cooling unit configured to cool the photo-detection section.

14. A target substance capturing device comprising:
a supporting member to place and support a metal-film coated structure that captures a target substance;
a holding member to put the metal-film coated structure in between the holding member and the supporting member, the holding member including a plurality of opening portions that overlaps with a portion that captures the target substance of the metal-film coated structure;
a covering member having transparency and covering the opening portions of the holding member; and
holes provided in the supporting member, and two of the holes opening to one of the opening portions, respectively, in a state where the metal-film coated structure is put in between the holding member and the supporting member.

15. The target substance capturing device according to claim 14, wherein, in one of the opening portions, a supply hole that supplies a liquid containing the target substance to the opening portion, and an discharge hole that discharges the liquid from the opening portion are provided as the holes.

16. The target substance capturing device according to claim 14, wherein a portion of the holding member, the portion being in contact with the metal-film coated structure, is formed of at least silicone.

17. The target substance capturing device according to claim 16, wherein the portion of the holding member, the portion being in contact with the metal-film coated structure, is formed of polydimethylsiloxane

18. The target substance capturing device according to claim 14, wherein the supporting member is formed of a fluororesin.

19. A target substance detecting device comprising:
the target substance capturing device according to claim 14;
a photo-detection section provided to each of the opening portions, and irradiating a portion that captures the target substance with parallel light from each of the opening portions, and detecting reflected light of the parallel light reflected at the portion that captures the target substance; and
a processing unit configured to obtain a wavelength of an extreme value of the reflected light detected by the photo-detection section, and to detect existence/non-existence of at least the target substance, based on shifting of the obtained wavelength of an extreme value.

20. The target substance detecting device according to claim 19, comprising:
a liquid sending device configured to supply the liquid to the space through the hole, and to discharge the liquid from the space through the hole.

21. A target substance capturing device comprising:
a flow path to flow a fluid containing a target substance; and
a substrate to capture the target substance, the substrate including a reflection surface that reflects irradiating light, wherein
the substrate is arranged in the flow path such that a part of the fluid passes through at least the reflection surface, and
the fluid that has passed through the flow path is repeatedly introduced to the flow path.

22. The target substance capturing device according to claim 21, wherein the flow path includes a supply port through which the fluid flows in, and a discharge port through which the fluid flows out, and
the fluid discharged through the discharge port is introduced to the flow path through the supply port.

23. The target substance capturing device according to claim 22, further comprising:
a container in which a new fluid containing a target substance is stored, wherein
the new fluid is introduced to the flow path through the supply port.

24. The target substance capturing device according to claim 21, further comprising:
a plate table;
a thin plate configured to overlap on the table in a vertical direction to a surface of the table, and including an opening portion; and
a plate cover configured to overlap on the thin plate in a vertical direction to a surface of the table, wherein
the flow path is a space surrounded by the table, an inner surface of the opening portion, and the cover.

25. The target substance capturing device according to claim 24, wherein the supply port and the discharge port are through holes provided in the table.
